(19) United States
(12) Patent Application Publication
(10) Pub. No.: US 2024/0107122 A1
(43) Pub. Date: Mar. 28, 2024

(54) PROVIDING RELEVANT INFORMATION DURING VIDEO PLAYBACK

(71) Applicant: Citrix Systems, Inc., Fort Lauderdale, FL (US)

(72) Inventors: Arnav Akhoury, Jamshedpur (IN); Akshit Akhoury, Jamshedpur (IN); Divyansh Deora, Bengaluru (IN); Anirudh Katoch, Bengaluru (IN)

(21) Appl. No.: 17/986,084

(22) Filed: Nov. 14, 2022

(30) Foreign Application Priority Data
Sep. 27, 2022 (IN) 202211055307

(51) Int. Cl. H04N 21/482; H04N 21/488

(52) U.S. Cl. CPC H04N 21/4828; H04N 21/488

(57) ABSTRACT

One disclosed method involves storing, in a storage medium, at least a first keyword corresponding to content of a video, after storing the first keyword, receiving, via a video playback application, an indication that playback of the video is initiated, in response to receipt of the indication, retrieving the first keyword from the storage medium, querying at least one data source for information corresponding to the first keyword, and causing a client device to display a representation of the information.

### CROSS-REFERENCE TO RELATED APPLICATIONS

This application claims priority under 35 U.S.C. § 119(a) to Provisional Application No. 202211055307, entitled PROVIDING RELEVANT INFORMATION DURING VIDEO PLAYBACK, which was filed with the Indian Patent Office on Sep. 27, 2022, the entire contents of which are incorporated herein by reference for all purposes.

### BACKGROUND

Various systems have been developed that allow client devices to access applications and/or data files over a network. Certain products offered by Citrix Systems, Inc., of Fort Lauderdale, FL, including the Citrix Workspace™ family of products and the Virtual Apps and Desktops™ systems, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method may involve storing, in a storage medium, at least a first keyword corresponding to content of a video, after storing the first keyword, receiving, via a video playback application, an indication that playback of the video is initiated, in response to receipt of the indication, retrieving the first keyword from the storage medium, querying at least one data source for information corresponding to the first keyword, and causing a client device to display a representation of the information.

In some disclosed embodiments, a computing system may comprise at least one processor at least one computer-readable medium encoded with instructions which, when executed by the at least one processor, cause the computing system to store, in a storage medium, at least a first keyword corresponding to content of a video, after storing the first keyword, receive, via a video playback application, an indication that playback of the video is initiated, in response to receipt of the indication, retrieve the first keyword from the storage medium, query at least one data source for information corresponding to the first keyword, and cause a client device to display a representation of the information.

In some disclose embodiments, at least one non-transitory computer-readable medium may be encoded with instructions which, when executed by at least one processor of a computing system, cause the computing system to store, in a storage medium, at least a first keyword corresponding to content of a video, after storing the first keyword, receive, via a video playback application, an indication that playback of the video is initiated, in response to receipt of the indication, retrieve the first keyword from the storage medium, query at least one data source for information corresponding to the first keyword, and cause a client device to display a representation of the information.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1 shows an example implementation of a system for providing relevant information during video playback, in accordance with some embodiments of the present disclosure;

FIG. 2 is a diagram of a network environment in which some embodiments of the user customizable activity feed generation system disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment;

FIG. 5C is a block diagram similar to that shown in FIG. 5B but in which the available resources are represented by a single box labeled “systems of record,” and further in which several different services are included among the resource management services;

FIG. 6A is a block diagram illustrating key components of a resource delivery system which may be useful for practicing embodiments described herein;

FIG. 6B illustrates an example deployment of a resource delivery system such as that shown in FIG. 6A;

FIG. 6C illustrates an example process for handling user connections within the deployment shown in FIG. 6B;

FIG. 6D shows examples of paths through which the resource manager and the resource monitor shown in FIG. 6B may access stored data;

FIG. 6E is a block diagram of a resource delivery system similar to the shown in FIG. 6A but in which several elements are provided as a service within a cloud-based computing environment;

FIG. 7A is a diagram illustrating how a network computing environment like that shown in FIG. 2 may be configured to allow clients access to an example embodiment of a server-based file sharing system;

FIG. 7B is a diagram illustrating certain operations that may be performed by the file sharing system shown in FIG. 7A in accordance with some embodiments;

FIG. 7C is a diagram illustrating additional operations that may be performed by the file sharing system shown in FIG. 7A in accordance with some embodiments;

FIG. 8 depicts an illustrative virtualized (hypervisor) system architecture that may be used in accordance with one or more illustrative aspects described herein;

FIG. 9 is a block diagram illustrating example components of the computing system shown in FIG. 1;

FIG. 10 shows an example routine that may be performed by the computing system shown in FIG. 9 during pre-processing operations for providing relevant information during video playback;

FIG. 11 shows another example routine that may be performed by the computing system shown in FIG. 9 to determine relevant information during video playback;

FIG. 12 shows another example routine that may be performed, in another implementation of the computing system shown in FIGS. 1 and 9, as part of pre-processing operations.

FIG. 13 shows another example routine that may be performed, in another implementation of the computing system shown in FIGS. 1 and 9, to present relevant information during video playback;

FIG. 14 shows another example routine that may be performed by the computing system shown in FIG. 9 to receive user feedback with respect to the relevant information;

FIG. 15 shows another example routine that may be performed by the computing system shown in FIG. 9 to receive user feedback with respect to keywords; and

FIG. 16 illustrates an example video application user interface including a portion where a video is displayed, and another portion where a representation of relevant information is displayed.

### DETAILED DESCRIPTION

When watching a video that, for example, relates to new subject matter or that is in an unfamiliar language, a user could be unfamiliar with certain content covered in the video. In a non-limiting example, a new employee, a new team member, etc., may watch videos describing a company's platform, tools used by a team, etc., to learn about the company and/or team. Certain terms that may be specific to the company or team and may cause confusion while the new employee/team member is attempting to learn about the company/team. In such cases, the user may pause the video and attempt to search for information regarding the unfamiliar terms. One of the drawbacks in this situation is that the user could lose focus on the video because of having to switch application windows to search for the information, needing to search multiple data sources, etc., which can lead to the user taking more time to finish viewing the video. Another issue is that the user may struggle to search for the right terms given the unfamiliarity with the video content. These issues may be even more noticeable when the video contents relate to technical subject matter, internal tools and components of an organization, are presented in an unfamiliar language to the user (e.g., English is a second language for the user), etc. These issues may also apply to a user that is familiar with most of the video content but may not be familiar with a few terms. The inventors have recognized and appreciated that unfamiliarity with video content can inhibit the user from learning efficiently.

Offered are systems and techniques for presenting relevant information to a user during video playback based on keywords determined from the video contents. For example, some techniques described herein involve storing at least one keyword corresponding to video contents, receiving an input initiating video playback, in response to receiving the input, retrieving the keyword from storage, querying one or more data sources for information related to the keyword, and causing display of the information. Example implementations may involve, prior to a user initiating playback processing videos to extract keywords (sometimes referred to herein as “pre-processing”) and storing the keywords for the videos. Some example implementations may further involve querying data sources using the stored keywords when a user initiates playback of the video. Other implementations may involve querying data sources using the stored keywords prior to a user initiating playback of the video. Information related to the keywords, and received from the data sources, may be presented to a user during video playback, and in some implementations, may be presented within the same application screen that the user is using to view the video.

In some example implementations, the information may further enable access to the data source, so that a user can view additional information available at the data source. In some implementations, the video playback may be automatically paused when a user selects a user interface element that enables access to the data source. Some implementations may enable a user to provide feedback with respect to the presented information (e.g., information is helpful, information is not helpful, etc.), and such feedback may be used to update the information presented during the video playback. Some implementations may involve presenting the keywords corresponding to the video contents, and enabling a user to provide feedback with respect to the keywords, where such feedback may be used to update the stored keywords for the video.

The techniques described herein provide an improved user experience by presenting relevant information during video playback in such manner that a user does not need to separately look for information. Furthermore, information from multiple data sources may be presented to a user, and mechanisms for receiving user feedback may also be provided.

For purposes of reading the description below of the various embodiments, the following descriptions of the sections of the specification and their respective contents may be helpful:
Section A provides an introduction to example embodiments of a system for providing relevant information during video playback;
Section B describes a network environment which may be useful for practicing embodiments described herein;
Section C describes a computing system which may be useful for practicing embodiments described herein;
Section D describes embodiments of systems and methods for accessing computing resources using a cloud computing environment;
Section E describes embodiments of systems and methods for managing and streamlining access by clients to a variety of resources;
Section F describes an example implementation of a resource delivery system which may be useful for practicing embodiments described herein;
Section G describes an example architecture of a resource virtualization server;
Section H describes example embodiments of systems for providing file sharing over networks;
Section I provides a more detailed description of example embodiments of the system for providing relevant information during video playback introduced in Section A; and
Section J describes example implementations of methods, systems/devices, and computer-readable media in accordance with the present disclosure.

### A. Introduction to Illustrative Embodiments of a System Providing Relevant Information During Video Playback

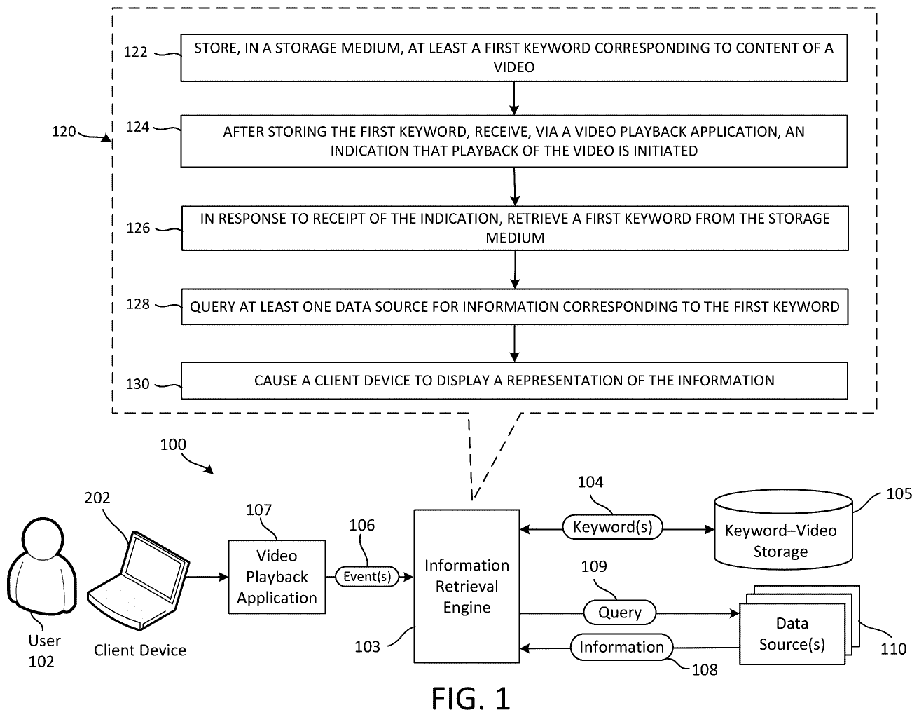

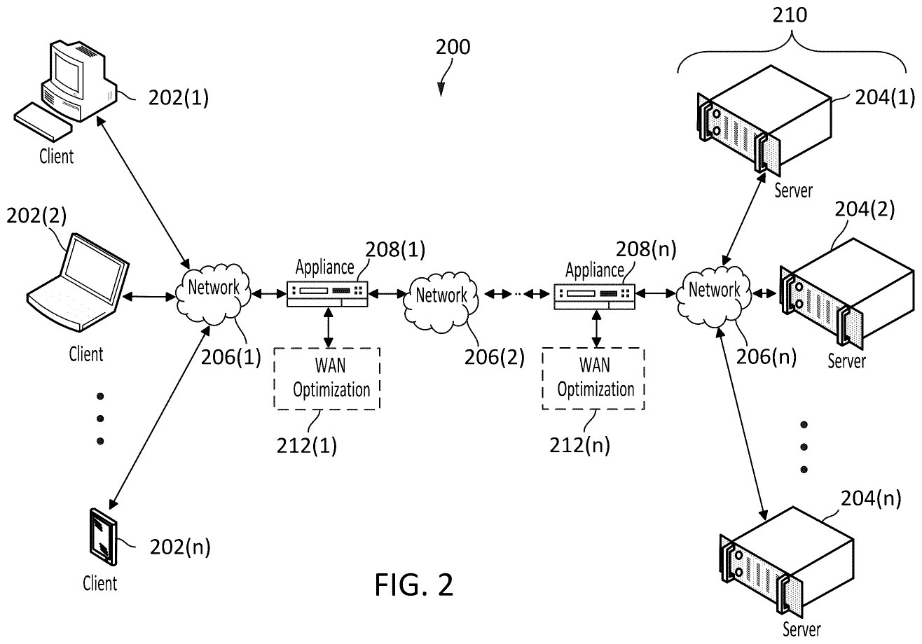

FIG. 1 shows an example configuration of a computing system 100 with which some aspects of the present disclosure may be implemented. As shown, the computing system 100 may include a client device 202 operated by a user 102, a video playback application 107, an information retrieval engine 103, a keyword-video storage 105 and one or more data sources 110. Components of the computing system 100 may be in direct or indirect communication with one another. The computing system 100 may be implemented, at least in part, by one or more servers 204. Examples of components that may be used to implement the client device 202 and such servers 204, as well as examples of computing environments in which such components may be deployed, are described below in connection with FIGS. 2-4.

The client device 202 may access the video playback application 107 for example, using a web browser, as an application installed at the client device 202, etc. The video playback application 107 may be configured to communicate certain events and/or data to the information retrieval engine 103. In some implementations, the video playback application 107 may include an application programming interface (API) to enable communications between the video playback application 107 and the information retrieval engine 103. In other implementations, the information retrieval engine 103 may be an add-in or plug-in of the video playback application 107, or may otherwise be included within or operate in conjunction with the video playback application 107.

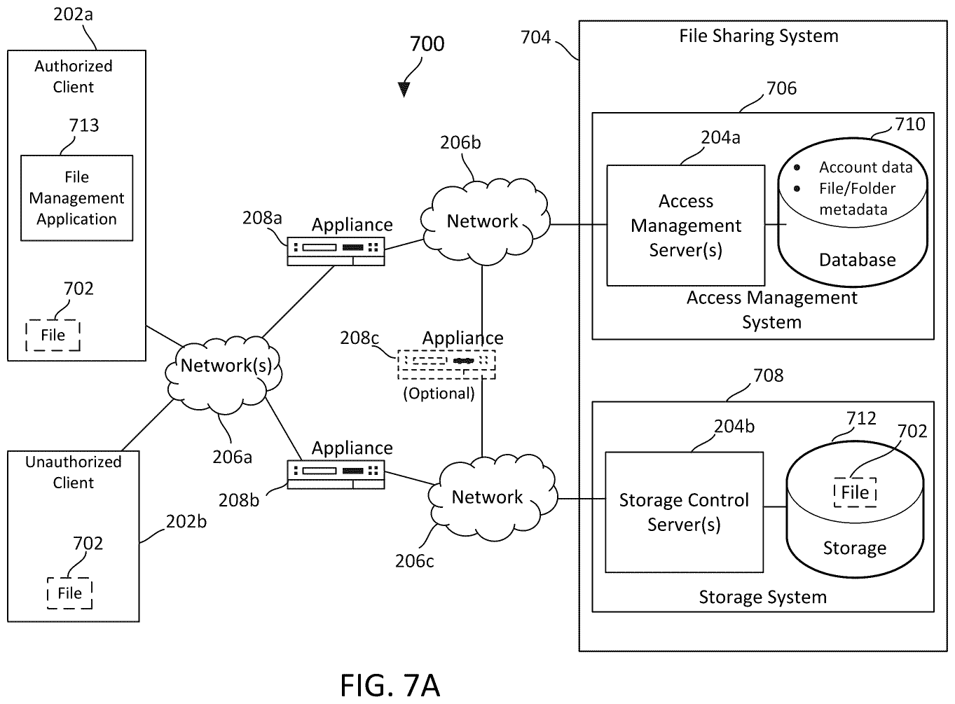

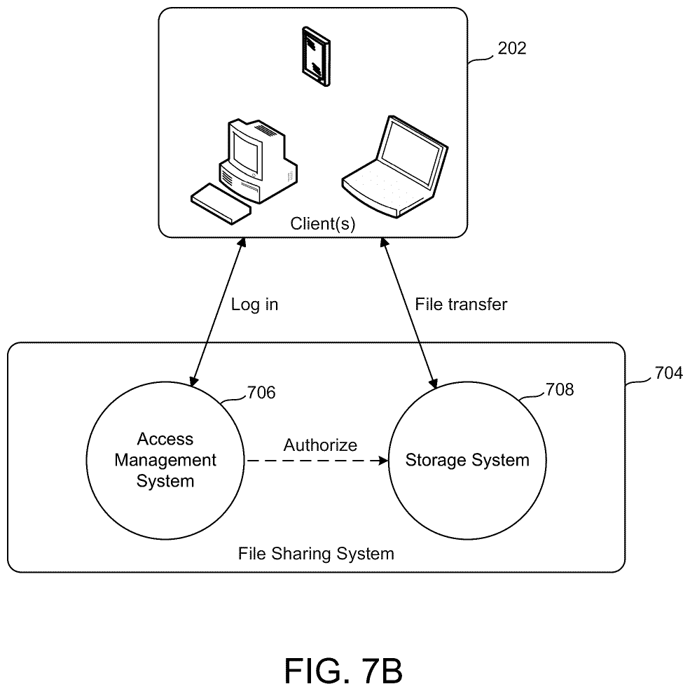

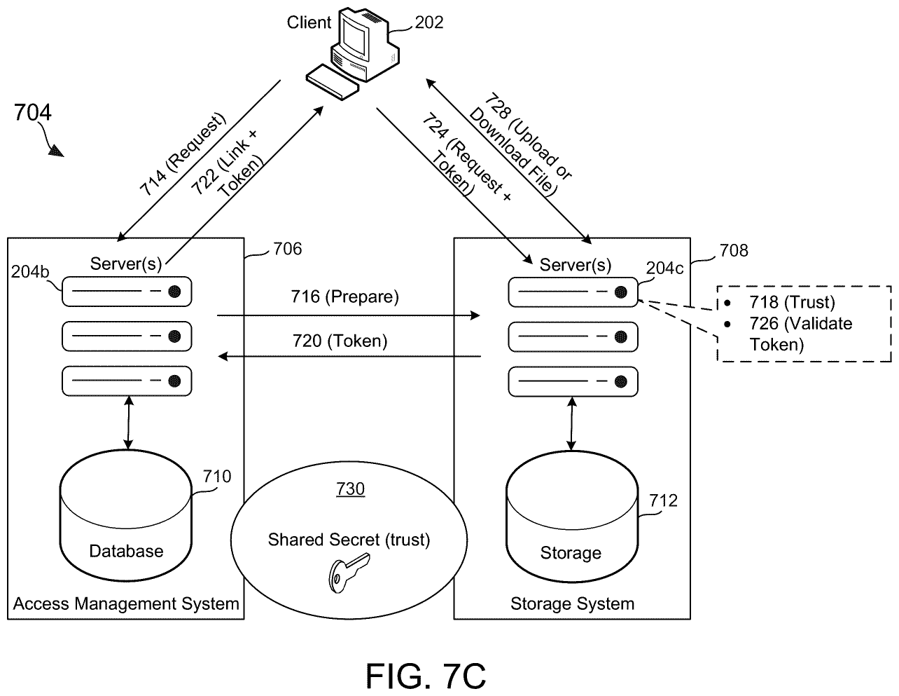

In some implementations, the computing system 100 may perform a routine 120 shown in FIG. 1. At a step 122 of the routine 120, the computing system 100 may store, in a storage medium (e.g., the keyword-video storage 105), at least a first keyword (e.g., one or more keywords 104) corresponding to contents of a video. In some implementations, the computing system 100 may store videos and corresponding data (e.g., upload time, uploading user, title, file tags, the keyword(s) 104, and other metadata) in the same storage medium or in separate storage mediums. Such videos may be uploaded or otherwise provided by various users to make them available to various other users. In some implementations, the videos may be uploaded to a file sharing system, such as the file sharing system 700 shown in FIGS. 7A-7C and described below in Section G. In such embodiments, the computing system 100 may include one or more components of, and/or operate in conjunction with, the file sharing system 700. In other implementations, the computing system 100 may be a content provider service that, among other things, makes videos for various subject matters available to users.

In some implementations, the computing system 100 may process contents of the video to determine the keyword(s) 104 corresponding to the video contents. In other implementations, the keyword(s) 104 may be provided along with the video (e.g., by a user that uploaded the video, by another component, etc.). The computing system 100 may store the keyword(s) 104 along with data identifying the video (e.g., file identifier, video title, etc.) and/or the video (and its metadata) itself in the keyword-video storage 105. The computing system 100 may store the keyword(s) 104 for individual videos as they are uploaded, as they are made available to view by other users, etc.

At a step 124 of the routine 120, after storing the first keyword(s) 104, the computing system 100 may receive, via the video playback application 107 executing on the computing system 100, an indication that playback of the video is initiated. The video playback application 107 may send an event 106 (e.g., PlayEvent( ), ButtonClick( ), etc.) to the information retrieval engine 103 indicating that the playback is initiated. The event 106 may include an indication of the video (e.g., video title, video file identifier, etc.). The event 106 may be generated and sent in response to the video playback application 107 receiving, via the client device 202, an input initiating playback of the video. For example, the user 102 may provide the input via the client device 202. The input may be provided using a mouse, a keyboard, a user interface element, a touch screen, etc. In some implementations, the input may be a speech input (e.g., the user 102 may say “play video [title]”).

In some embodiments, the video playback application 107 may be a media player application, such as Windows Media Player, YouTube, QuickTime Player, VLC media player, etc.

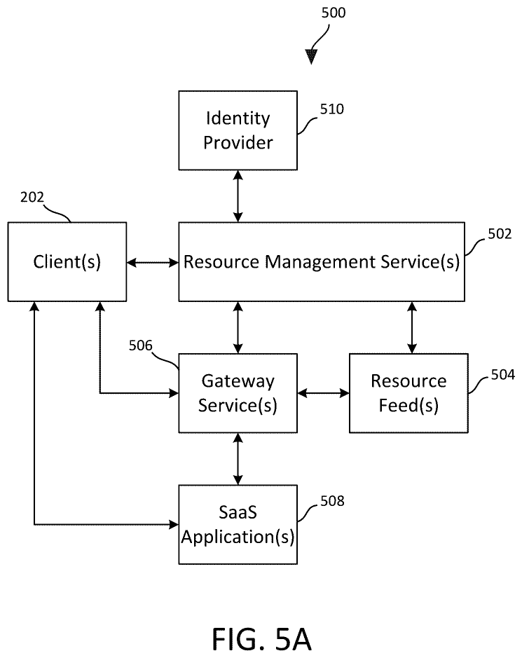

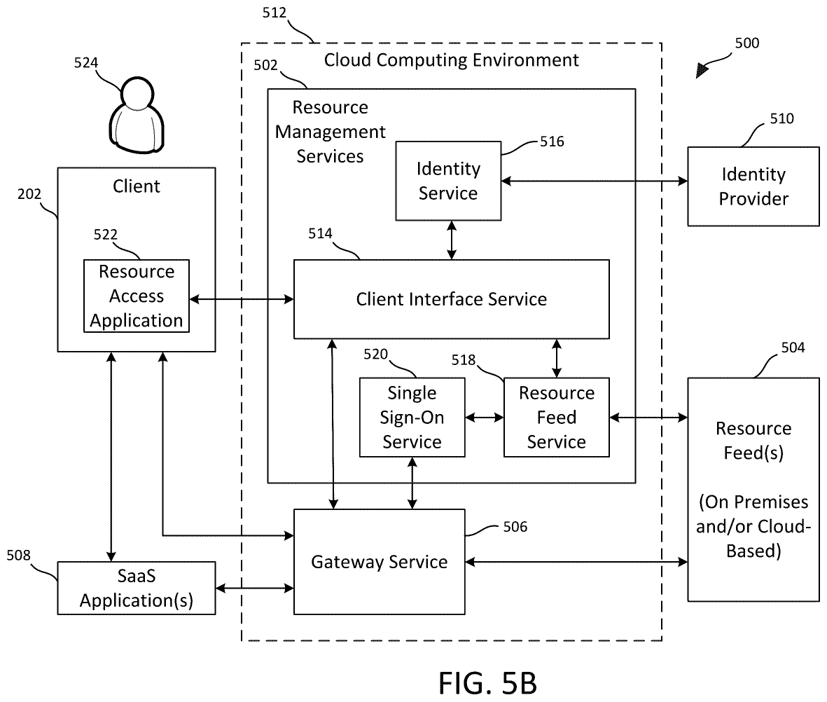

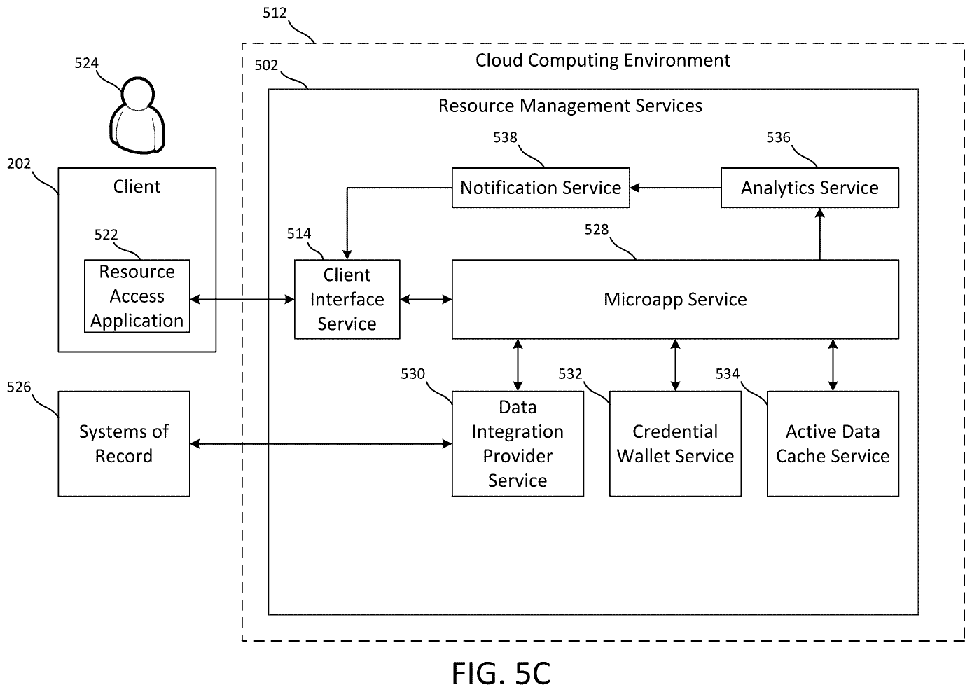

In other embodiments, the video playback application 107 may be accessed using a resource access application 522 of a multi-resource access system 500 shown in FIGS. 5B-5C and described below in Section E. The user 102 may, for example, access one or more SaaS applications 508 or other resources 504, via the client device 202, using the user interface of the resource access application 522. In some implementations, one of the SaaS applications 508 or other resources 504 accessed by the user 102 may be a video playback application via which the user 102 can access videos and provide an input(s) to initiate playback of the video. In such embodiments, the computing system 100 may include one or more components of, and/or operate in conjunction with, the multi-resource access system 500 shown in FIGS. 5A-5C and described below in Section E.

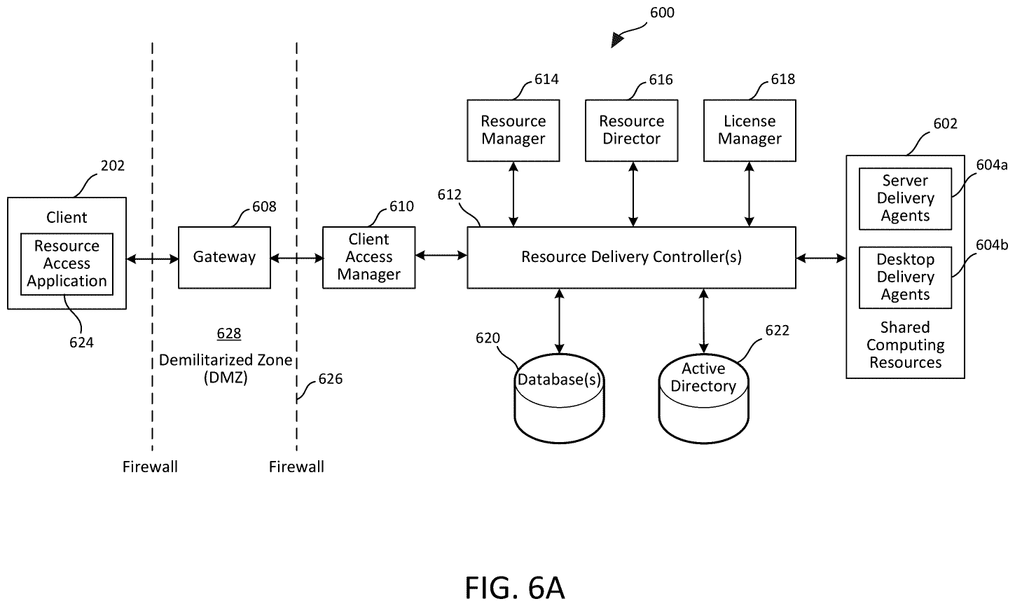

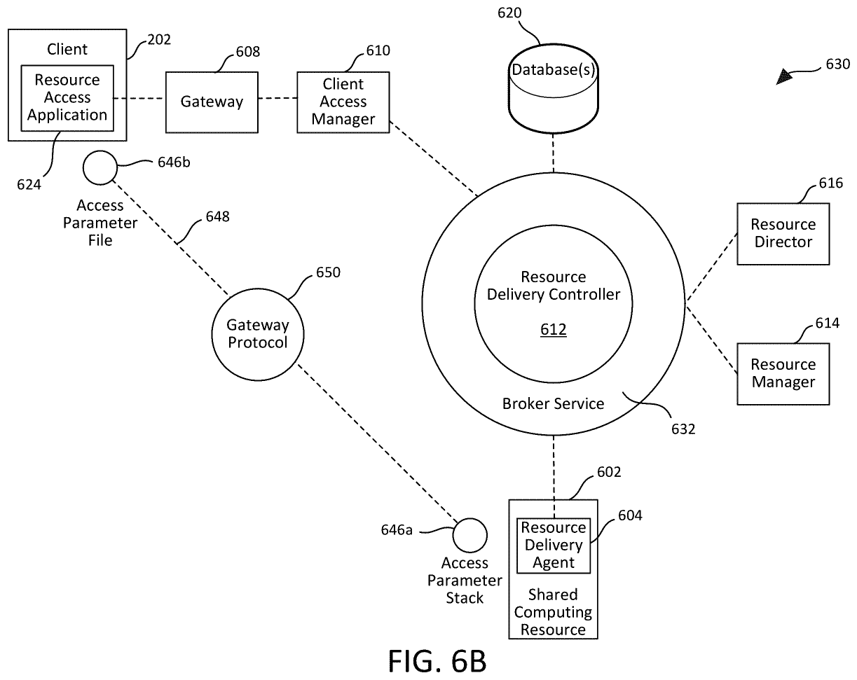

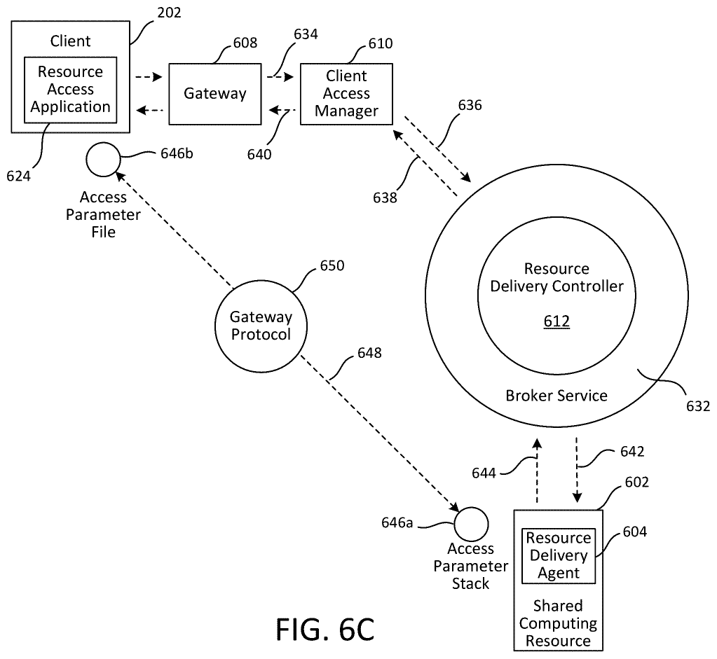

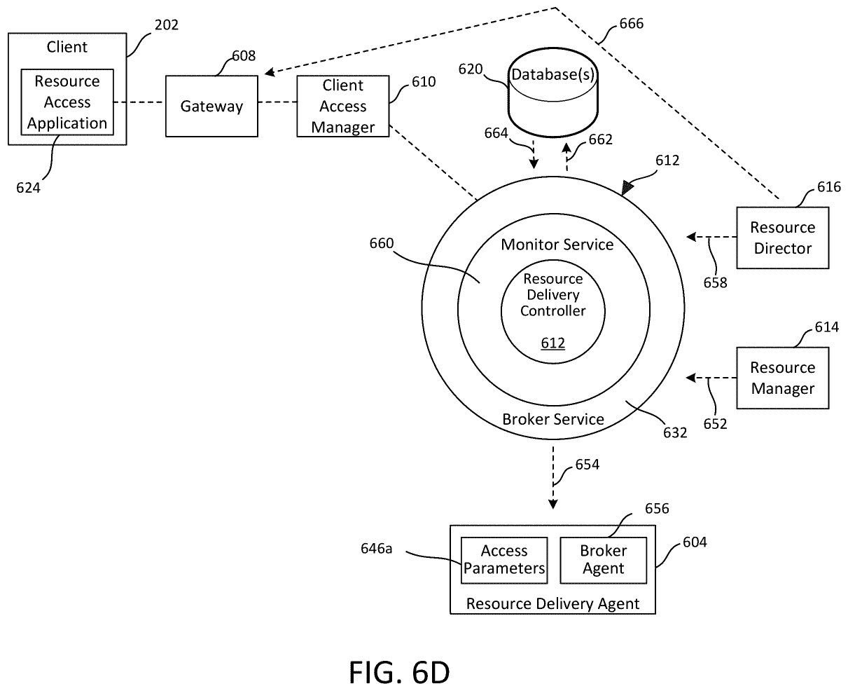

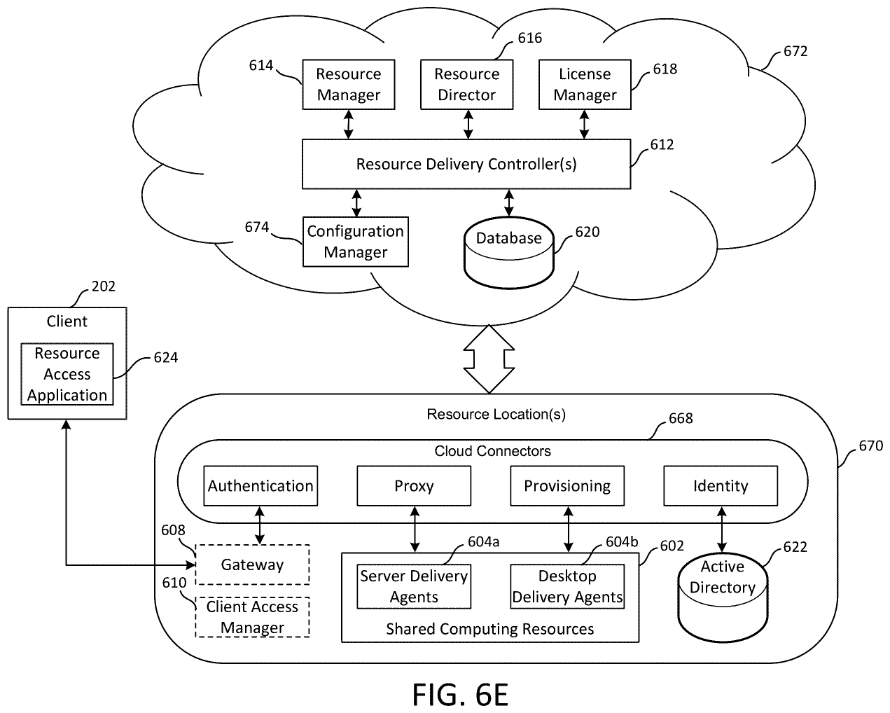

In other embodiments, the video playback application 107 may be accessed via a resource access application 624 of the resource delivery system 600 shown in FIGS. 6A-6E and described below in Section F. The user 102 may, for example, remotely access one or more desktops and/or virtual applications, at the client device 202, using the resource access application 624. In such implementations, the user 102 may use the resource access application 624 to launch a video playback application on one or more shared computing resources 602 (shown in FIGS. 6A-6E), and may provide an input(s) to such a video playback application to access the video. In such embodiments, the computing system 100 may include one or more components of, and/or operate in conjunction with, the resource delivery system 600 shown in FIGS. 6A-6E and described below in Section F.

In yet other embodiments, the video playback application 107 may be an application provided by the file sharing system 700 to access videos uploaded/shared via the file sharing system 704 shown in FIGS. 7A-7C and described below in Section G. The user 102 may, for example, open a file management application 713 at the client device 202 to access a shared video and provide the input initiating playback of the video. In such embodiments, the computing system 100 may include one or more components of, and/or operate in conjunction with, the file sharing system 700 shown in FIGS. 7A-7C and described below in Section G.

At a step 126 of the routine 120, in response to receipt of the indication, the computing system 100 may retrieve the first keyword(s) 104 from the keyword-video storage 105. In some implementations, the information retrieval engine 103 may retrieve the first keyword(s) 104 based on it being associated with the video of which the user 102 initiated playback. In some implementations, the information retrieval engine 103 may include the keyword-video storage 105, or may be in communication with the keyword-video storage 105.

At a step 128 of the routine 120, the computing system 100 may query at least one data source (e.g., one or more of data sources 110) for information corresponding to the first keyword(s) 104. In some implementations, the information retrieval engine 103 may send a query 109 to the data source(s) 110. The data sources 110 may include, but are not limited to, a file sharing system, an intranet system, an email system, a messaging system, and/or a web search engine. In some implementations, the information retrieval engine 103 may determine which data sources 110 the user 102 is authorized to access. In some implementations, the information retrieval engine 103 may access one or more of the data sources 110 using user credentials associated with the user 102. In accessing the data source(s) 110 using such credentials, the information retrieval engine 103 may be able to find information that is accessible and pertinent to the user 102. For example, the computing system 100 may send the query 109 to a file sharing system, accessible by the user 102, and may retrieve one or more files corresponding to the first keyword(s) 104. As another example, the information retrieval engine 103 may send the query 109 to an intranet system accessible by the user 102, and may retrieve links or other types of information corresponding to the first keyword(s) 104. As yet another example, the information retrieval engine 103 may send the query 109 to an email system accessible by the user 102, and may retrieve one or more emails corresponding to the first keyword(s) 104. In some implementations, the information retrieval engine 103 may send the query 109, which causes performance of a web search (e.g., using a search engine such as Google, Bing, etc.) for information corresponding to the first keyword(s) 104.

In some embodiments, such as where the user 102 views the video via a video playback application 107 that is accessed using the resource access application 522, one or more of the data sources 110 may be the SaaS applications 508 that the user 102 is authorized to access.

In some embodiments, such as where the user 102 views the video via a video playback application 107 that is accessed using the resource access application 624, one or more of the data sources 110 may be resources hosted at the shared computing resources 602 that the user 102 is authorized to access.

Based on querying the data source(s) 110, the information retrieval engine 103 may receive multiple search results corresponding to the first keyword(s) 104. In some embodiments, the information retrieval engine 103 may filter, prune, rank and/or perform other type of processing on the received search results to determine which information 108 from the search results is to be presented to the user 102.

The information 108 may, for example, include one or more files from a file sharing system, information from an intranet system, one or more emails from an email system, one or more messages/conversations from a messaging system, and/or one or more web search results. In some implementations, the computing system 100 may determine a representation of the information 108, where the representation may be a summary of the information 108, and may include a title or the first keyword(s) 104 to indicate the keyword(s) to which the information 108 corresponds.

At a step 130 of the routine 120, the computing system 100 may cause the client device 202 to display a representation of the information 108. In some implementations, the representation of the information 108 may be presented via the video playback application 107 while the video is being played. The information 108 may be presented via “cards” that are displayed alongside a user interface that is showing the video. The representation of the information 108 may include a selectable user interface element, such as a hyperlink, a button, etc., selection of which (e.g., clicking using a mouse, selecting via a touch input, etc.) may enable the user 102 to access the corresponding information 108 or other information at the data source 110 from which the information 108 is derived. For example, if the information 108 is derived from an intranet page then selecting the corresponding user interface element may open the intranet page where the user 102 can be access the information 108 and/or additional information corresponding to the first keyword 104.

In some implementations, the information 108 may be presented at the client device 202 via an extension to the video playback application 107, a plug-in for the video playback application 107, another application or other mechanism. The information retrieval engine 103 may send a command and/or data to the video playback application 107 or the other application, to cause presentation of the information 108, along with the video playback. In some implementations, for example, the information retrieval engine 103 may include or operate in conjunction with an application that causes the video to be played back in one sub-window of the application and that further causes the information 108 to be presented in another sub-window of the application. Any of a number of other configurations to allow the video and the information 108 to be presented simultaneously on a screen of the client device 202 are also possible.

Additional details and example implementations of embodiments of the present disclosure are set forth below in Section I, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, FL, such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, FL, such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

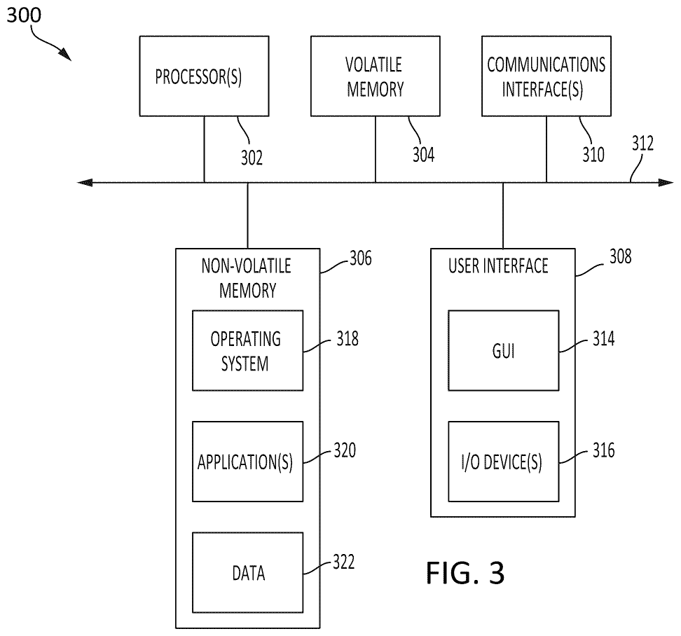

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

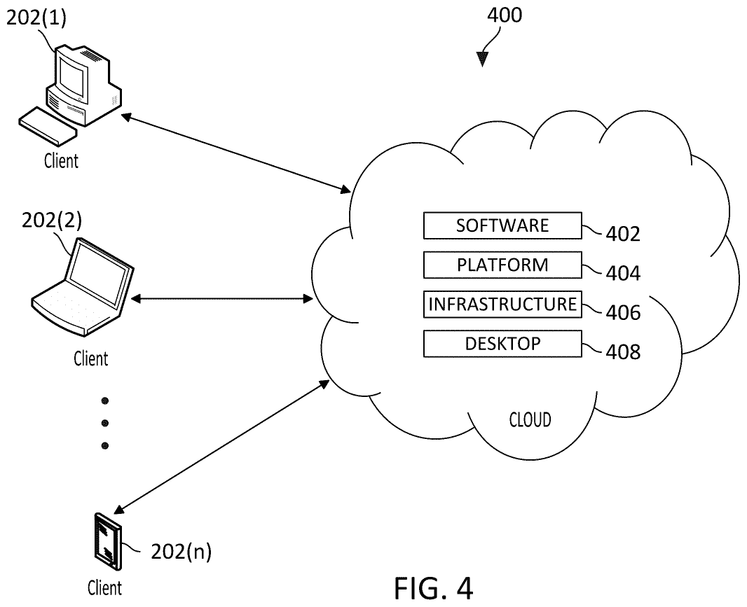

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Washington, or AMAZON WEB SERVICES provided by Amazon.com, Inc., of Seattle, Washington, for example. In the case of Citrix Cloud, Citrix Workspace app may be used as a single-entry point for bringing apps, files and desktops together (whether on-premises or in the cloud) to deliver a unified experience.

### E. Systems and Methods for Managing and Streamlining Access by Client Devices to a Variety of Resources

FIG. 5A is a block diagram of an example multi-resource access system 500 in which one or more resource management services 502 may manage and streamline access by one or more clients 202 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 202 and, following authentication, identify one or more resources the user is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

The client(s) 202 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 202, one or more file repositories and/or file sharing systems, one or more secure browser services, one or more access control services for the SaaS applications 508, one or more management services for local applications on the client(s) 202, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 202) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 202 may use a resource access application 522 to communicate with the client interface service 514 as well as to present a user interface on the client 202 that a user 524 can operate to access the resource feed(s) 504 and/or the SaaS application(s) 508. The resource access application 522 may either be installed on the client 202, or may be executed by the client interface service 514 (or elsewhere in the multi-resource access system 500) and accessed using a web browser (not shown in FIG. 5B) on the client 202.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., username and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 202 to be redirected to the cloud-based identity service to complete an authentication process. The cloud-based identity service may then cause the client 202 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 202 may proceed to access the selected resource.

When the user 524 selects a local application, the resource access application 522 may cause the selected local application to launch on the client 202. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508.

In some embodiments, the preferred browser identified by the gateway service 506 may be a specialized browser embedded in the resource access application 522 (when the resource application is installed on the client 202) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 202, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources-SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 202. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and 6ML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically pull active data from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 202 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 202 as a push notification to the user 524.

In some embodiments, a process for processing a user-initiated action via a microapp may operate as follows. The client 202 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

F. Systems and Methods for Delivering Virtualized Applications and/or Desktops to Client Devices

FIG. 6A is a block diagram illustrating key components of a resource delivery system 600 that may enable a client device 202 to remotely access one or more virtual applications or desktops running on one or more shared computing resources 602. The shared computing resources 602 may include physical machines and/or virtual (e.g., hypervisor driven) machines, and may be located at a data center, within a cloud computing environment, or elsewhere. As described in more detail below, such shared computing resources 602 may implement one or more resource delivery agents 604, including one or more server delivery agents 604a and/or one or more desktop delivery agents 604b. The Virtual Delivery Agents (VDAs) of the Citrix Virtual Apps and Desktops™ system offered by Citrix Systems, Inc., of Fort Lauderdale, Florida, are example implementations of the resource delivery agents 604. In some implementations, the resource delivery system 600 may give an information technology (IT) department of an organization control of virtual machines, applications, licensing, and security while providing “anywhere access” for any device. As described below, the resource delivery system 600 may enable end users to run applications and/or desktops independently of the operating system and interface of the end user's device. Further, the resource delivery system 600 may enable administrators to manage the network and control access from selected devices or from all devices, as well as to manage an entire network from a single data center.

The resource delivery system 600 shown in FIG. 6A may, for example, correspond to an implementation of a Citrix Virtual Apps and Desktops™ system offered by Citrix Systems, Inc., of Fort Lauderdale, Florida. Such systems employ a unified architecture called FlexCast Management Architecture (FMA). Among other things, FMA provides the ability to run multiple versions of Citrix Virtual Apps or Citrix Virtual Desktops™ as well as integrated provisioning.

As shown in FIG. 6A, in addition to the shared computing resources 602, the resource delivery system 600 may include a gateway 608, a client access manager 610, one or more resource delivery controllers 612, a resource manager 614, a resource director 616, a license manager 618, one or more databases 620, and an Active Directory (AD) 622 or other directory service.

The resource delivery controller(s) 612 may be the central management component of the resource delivery system 600. In some implementations, the resource delivery controller(s) 612 may be installed on at least one server in a data center of an organization. The Delivery Controller of the Citrix Virtual Apps and Desktops™ system offered by Citrix Systems, Inc., of Fort Lauderdale, Florida, is one example implementation of the resource delivery controller(s) 612. For reliability and availability, respective resource delivery controllers 612 may be installed on multiple servers. The resource delivery controller(s) 612 may communicate with the shared computing resources 602 to distribute applications and/or desktops, authenticate and manage user access, broker connections between client devices 202 and resource delivery agents 604 running on respective shared computing resources 602, optimize use connections, and/or load-balance use connections. As described in more detail below, a broker service 632 (shown in FIGS. 6B-6D) of the resource delivery controller(s) 612 may interact with the database(s) 620 to track which users are logged on and where, what session resources the users have, and if users need to reconnect to existing applications. In some implementations, the broker service 632 may execute PowerShell commands and communicate with broker agents 656 (shown in FIG. 6D) of the resource delivery agents 604 over transmission control protocol (TCP) port “80.” A monitor service 660 (shown in FIG. 6D) may also be provided by the resource delivery controller(s) 612 to collect historical data concerning the operation of the resource delivery controller(s) 612 and write such data to the database(s) 620. In some implementations, such a monitor service 660 may use TCP port “80” or “443.”

The resource delivery controller(s) 612 may manage the state of desktops, starting and stopping them based on demand and administrative configuration. In some implementations, the resource delivery controller(s) 612 may also enable the adjustment of user profiles (stored within the database(s) 620) to manage user personalization settings in virtualized or physical Windows environments.

In some implementations, the database(s) 620 may include at least one Microsoft Structured Query Language (SQL) Server database in which configuration and session information may be stored. As noted above, the database(s) 620 may store the data collected and managed by the services that make up the resource delivery controller(s) 612. In some implementations, the database(s) 620 may be provided within a data center of an organization and may have a persistent connection to the resource delivery controller(s) 612. Although not illustrated in FIG. 6A, it should be appreciated that the resource delivery system 600 may also include respective databases associated with the resource manager 614, the resource director 616, and the license manager 618 to store data collected and/or used by those components.

The resource delivery agents 604 may be installed on physical or virtual machines that are made available to deliver applications or desktops to users. The resource delivery agents 604 may enable such machines to register with the resource delivery controller(s) 612. The registration of a machine with the resource delivery controller(s) 612 may cause that machine and the resources it is hosting to be made available to users. The resource delivery agents 604 may establish and manage the connections between the machines on which they are installed and client devices 202. The resource delivery agents 604 may also verify that a license is available for the user and/or session, and may apply policies that are configured for the session.

The resource delivery agents 604 may communicate session information to the broker service 632 (shown in FIGS. 6B-6D) of the resource delivery controller(s) 612 through the broker agents 656 (shown in FIG. 6D) in the resource delivery agents 604. Such broker agents 656 may host multiple plugins and collect real-time data. In some implementations, the broker agents 656 may communicate with the resource delivery controller(s) 612 over TCP port “80.” In some implementations, the resource delivery agents 604 may operate with Single-session and/or Multi-session Windows operating systems. The resource delivery agents 604 for Multi-session Windows operating systems may allow multiple users to connect to the server at one time. The resource delivery agents 604 for Single-session Windows operating systems, on the other hand, may allow only one user to connect to the desktop at a time. In some implementations, one or more the resource delivery agents 604 may alternatively operate with a Linux operating system.

When users connect from outside one or more corporate firewalls, e.g., firewalls 626a and 626b shown in FIG. 6A, the gateway 608 may be used to secure such connections with Transport Layer Security (TLS). The gateway 608 may, for example, be a Secure Socket Layer (SLL) Virtual Private Network (VPN) appliance that is deployed in a demilitarized zone (DMZ) 628. The gateway 608 may thus provide a single secure point of access through the corporate firewall 626.

The client access manager 610 of the resource delivery system 600 may authenticate users and manage stores of desktops and/or applications that are available for users to access. In some implementations, the client access manager 610 may provide an application “storefront” for an enterprise, which may provide users with self-service access to the desktops and/or applications that the enterprise opts to make available to them. In some implementations, the client access manager 610 may also keep track of users' application subscriptions, shortcut names, and other data. Tracking such data may, for example, help ensure that users have a consistent experience across multiple devices.

As shown in FIG. 6A, a resource access application 624 may be installed on client devices 202 or other endpoints (such as virtual desktops). Such resource access applications 624 may provide users with quick, secure, self-service access to documents, applications, and/or desktops. The resource access application 624 may, for example, provide on-demand access to Windows, web, and/or Software as a Service (SaaS) applications. The Citrix Workspace™ app, offered by Citrix Systems, Inc., of Fort Lauderdale, Florida, is one example implementation of such a client-based version of the resource access application 624. In some implementations, the resource access application 624 may alternatively operate on a web server (not shown in FIG. 6A) and may be accessed using a web browser (also not shown in FIG. 6A) installed on the client device 202. In some embodiments, for example, the resource access application 624 may be provided as a hypertext markup language 5 (HTML5) service and may be accessed using an HTML5-compatible web browser. The Citrix Workspace™ app for HTML5, offered by Citrix Systems, Inc., of Fort Lauderdale, Florida, is one example implementation of such a web-based version of the resource access application 624.

In some embodiments, the resource access application 624 may intercept network communications from a network stack used by the one or more applications. For example, the resource access application 624 may intercept a network communication at any point in a network stack and redirect the network communication to a destination desired, managed, and/or controlled by the resource access application 624, for example, to intercept and redirect a transport layer connection to an IP address and port controlled and/or managed by resource access application 624. The resource access application 624 may thus, in some embodiments, transparently intercept any protocol layer below the transport layer, such as the network layer, and any protocol layer above the transport layer, such as the session, presentation, or application layers. The resource access application 624 may, for example, interface with the transport layer to secure, optimize, accelerate, route, and/or load-balance any communications provided via any protocol carried by the transport layer.

In some embodiments, the resource access application 624 may be implemented as an Independent Computing Architecture (ICA) client developed by Citrix Systems, Inc. The resource access application 624 may perform acceleration, streaming, monitoring, and/or other operations. For example, the resource access application 624 may accelerate streaming an application from a shared computing resource 602 running a resource delivery agent 604 to the client device 202. The resource access application 624 may also perform endpoint detection/scanning and/or collect endpoint information about the client 202. For example, the resource access application 624 may identify and determine one or more client-side attributes, such as: the operating system and/or a version of an operating system, a service pack of the operating system, a running service, a running process, a file, presence or versions of various applications of the client, such as antivirus, firewall, security, and/or other software.

The resource manager 614 shown in FIG. 6A, may provide a console from which the configuration and management of applications and desktops that are to be made available to users may be controlled. The Studio component of the Citrix Virtual Apps and Desktops™ system offered by Citrix Systems, Inc., of Fort Lauderdale, Florida, is one example implementation of the resource manager 614. In some implementations, the resource manager 614 may eliminate the need for separate management consoles for managing delivery of applications and desktops. In some embodiments, the resource manager 614 may provide one or more wizards to guide system administrators through environment setup, creating workloads to host applications and desktops, and assigning applications and desktops to users. In some implementations, the resource manager 614 may also be used to allocate and track licenses for the resource delivery system 600. In some embodiments, the resource manager 614 may get the information it displays from the broker service 632 of the resource delivery controller(s) 612, e.g., communicating over TCP port “80.”

The resource director 616 may, for example, be a web-based tool that enables IT support and help desk teams to monitor an environment, troubleshoot issues before they become system-critical, and perform support tasks for end users. The Director component of the Citrix Virtual Apps and Desktops™ system offered by Citrix Systems, Inc., of Fort Lauderdale, Florida, is one example implementation of the resource director 616. In some implementations, a single deployment of the resource director 616 may be used to connect to and monitor multiple resource delivery systems 600, such as that shown in FIG. 6A. Examples of information that may be displayed by the resource director 616 include (A) real-time session data from the broker service 632 of the resource delivery controller(s) 612, which may include data the broker service 632 gets from the broker agent 656 in the resource delivery agents 604, and (B) historical data about the resource delivery system 622 that may be received, for example, from the monitor service 660 in the resource delivery controller(s) 612. In some implementations, the resource director 616 may use performance and heuristics data captured by the gateway 608 (described below) to build analytics from the data and then presents such analytics to system administrators. Further, in some implementations, the resource director 616 may allow system administrators to view and interact with a user's sessions, e.g., using Windows Remote Assistance.

The license manager 618, as its name implies, may enable the management of licenses within the resource delivery system 600. In some implementations, the license manager 618 may communicate with the resource delivery controller(s) 612 to manage licensing for a user's session and with the resource manager 614 to allocate license files.

As noted above, in some implementations, the shared computing resources 602 shown in FIG. 6A may include one or more virtual machines. These can be virtual machines that are used to host applications and/or desktops, as well as virtual machines that are used to host the other components of the resource delivery system 600. In some implementations, a hypervisor may be installed on a host computer to run the hypervisor and hosting virtual machines.

Although not depicted in FIG. 6A, in some implementations, the resource delivery system 600 may additionally include a performance monitoring service or agent. In some embodiments, one or more dedicated servers (or a dedicated service in a cloud-based environment) may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on one or more clients 202 (e.g., as a part of the resource access application 624), one or more servers 204, or one or more other system component(s). In general, the monitoring agents may execute transparently (e.g., in the background) to any application and/or user of the device. In some embodiments, such a monitoring agent may be implemented as components of Citrix Analytics™ by Citrix Systems, Inc., of Fort Lauderdale, FL.

The monitoring agents may, for example, monitor, measure, collect, and/or analyze data on a frequency (e.g., a predetermined frequency), based upon an occurrence of given event(s), or in real time during operation of the resource delivery system 600. The monitoring agents may, for example, monitor resource consumption and/or performance of hardware, software, and/or communications resources of the clients 202, the gateway 608 (and/or any other components in the DMZ 628), and/or the resource delivery controller(s) 612, the shared computing resources 602, the resource delivery agents 604, or any other components shown in FIG. 6A. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents may provide application performance management for the resource delivery system 600. For example, based upon one or more monitored performance conditions or metrics, the resource delivery system 600 may be dynamically adjusted, for example periodically or in real-time, to optimize application delivery by the resource delivery agents 604 to the clients 202 based upon network environment performance and conditions

FIG. 6B illustrates an example deployment 630 of a resource delivery system 600, such as that shown in FIG. 6A. Such a deployment may be referred to as a “Site.” A Site may be made up of machines with dedicated roles that allow for scalability, high availability, and failover, and may provide a solution that is secure by design. As discussed above, such a Site may include servers and/or desktop machines installed with resource delivery agents 604, and one or more resource delivery controller(s) 612, which may manage access to such servers/machines. FIG. 6B illustrates one such resource delivery agent 604, and one such resource delivery controller 612. As shown in FIG. 6B, the resource delivery controller 612 may include a broker service 632. The resource delivery agent 604 may enable users to connect to desktops and/or applications. It may be installed on server or desktop machines in a datacenter for most delivery methods, but it may also be installed on physical personal computers (PCs) for Remote PC Access. In some implementations, the resource delivery controller 612 may be made up of independent Windows services that may manage resources, applications, and/or desktops, and may optimize and balance user connections.

In some embodiments, client devices 202 may not directly access the resource delivery controller 612. Instead, the resource delivery agent 604 and the client access manager 610 may serve as intermediaries between client devices 202 and the resource delivery controller 612. When users log on using the client access manager 610, their credentials may pass through to the broker service 632 on the resource delivery controller 612. The broker service 632 may then obtain profiles and available resources based on the policies set for them.

FIG. 6C illustrates an example process for handling user connections within the deployment 630 shown in FIG. 6B. As indicated by arrows 634 and 635, to start a session, a user may cause the client device 202 to connect (via the gateway 608) to the client access manager 610. Such a connection may, for example, be established using the resource access application 624. As noted above, the resource access application 624 may either be installed on the client device 202 or accessible from a web server via a web browser on the client device 202.

As indicated by arrow 636, the user's credentials may then move through this pathway to access the broker service 632 of resource delivery controller 612. In some implementations, such communications may be encrypted to protect the security of such credentials. The broker service 632 may determine which desktops and/or applications the user is allowed to access. After the credentials have been verified, information about available applications and/or desktops may be sent back to the client device 202 through the pathway between the client access manager 610 and the resource access application 624, as indicated by arrows 638, 640, and 641. The user of the client device 202 may thus be provided with a list of available applications and/or desktops. When the user selects an application or desktop from this list, an indication of the selected resource goes back down the previously described pathway to the resource delivery controller 612. The resource delivery controller 612 may then select an appropriate resource delivery agent 604 to host the selected applications or desktop.

As indicated by arrow 642, the resource delivery controller 612 may send a message to the selected resource delivery agent 604 with the user's credentials, and may then send pertinent data about the user and the connection to the resource delivery agent 604. The resource delivery agent 604 may then accept the connection and, as indicated by arrows 644, 638, 640, and 641, may send a set of access parameters (stored in an access parameter stack 646a) back through the same pathways to the resource access application 624. In particular, the set of access parameters may be collected by the client access manager 610 and then sent to the resource access application 624 where they may be stored as an access parameter file 646b. In some implementations, the access parameter file 646b may be created as part of a protocol conversation between the client access manager 610 and the resource access application 624. In other implementations, the client access manager 610 may convert the access parameters to the file 646b, and that file 646b may then be downloaded to the client device 202. In some implementations, the access parameters may remain encrypted throughout this process.

The access parameter file 646b that is then stored on the client device 202 may be used to establish a direct connection 648 between the client device 202 and the access parameter stack 646a running on the resource delivery agent 604. As illustrated, the connection 648 between the client device 202 and the resource delivery agent 604 may use a gateway protocol 650. In some implementations, the gateway protocol 650 may include a feature that enables the client device 202 to immediately reconnect to the resource delivery agent 604 if the connection 648 is lost, rather than having to relaunch through the management infrastructure (including the client access manager 610, the resource delivery controller 612, etc.).

After the client device 202 connects to the resource delivery agent 604, the resource delivery agent 604 may notify the resource delivery controller 612 that the user is logged on. The resource delivery controller 612 may then send this information to the database(s) 620 (shown in FIGS. 6A, 6B and 6D) and the monitor service 660 (shown in FIG. 6D) of the delivery controller 612 may also start logging data in the database(s) 620.

Such sessions between client devices 202 and resource delivery agents 604 produce data that system administrators can access through the resource manager 614 and/or the resource director 616. FIG. 6D shows examples of paths through which the resource manager 614 and the resource director 616 may access such data in some embodiments. As indicated by the arrows 652 and 654, administrators may use the resource manager 614 to access real-time data from the broker agent 656 of a resource delivery agent 604 (via the broker service 632 of the resource delivery controller 612). The resource director 616 may access the same data, as indicated by arrows 658 and 654, plus any historical data the monitor service 660 of the resource delivery controller 612 stores in the database(s) 620, as indicated by arrows 658, 662 and 664. Further, as indicated by arrow 666, the resource director 616 may also access data from the gateway 608 for help desk support and troubleshooting.

Within the resource delivery controller 612, the broker service 632 may report session data for every session on the machine providing real-time data. The monitor service 660 may also track the real-time data and store it as historical data in the database(s) 620. In some implementations, the resource manager 614 may communicate with the broker service 632 and may access real-time data. The resource director 616 may communicate with the broker service 632 to access the database(s) 620.

An example process for enabling the delivery of applications and/or desktops will now be described. First, the machines that are to deliver applications and/or desktops may be set up with “Machine Catalogs.” Then, “Delivery Groups” may be created that specify the applications and/or desktops that are to be made available (using machines in the Machine Catalogs), and which users can access them. In some implementations, “Application Groups” may also be created to manage collections of applications.

Machine Catalogs are collections of virtual or physical machines that can be managed as a single entity. These machines, and the application and/or virtual desktops on them, are the resources that may be made available to users. All the machines in a Machine Catalog may have the same operating system and the same resource delivery agent 604 installed. They may also have the same applications and/or virtual desktops.

In some implementations, a master image may be created and used to create identical virtual machines in the catalog. For virtual machines, the provisioning method may be specified for the machines in that catalog. Valid machine types may, for example, include “Multi-session OS,” “Single-session OS,” and “Remote PC access.” A Multi-session OS machine is a virtual or physical machine with a multi-session operating system. Such a machine may be used to deliver published applications (also known as server-based hosted applications) and published desktops (also known as server-hosted desktops). These machines may allow multiple users to connect to them at one time. A Single-session OS machine is a virtual or physical machine with a single-session operating system. Such a machine may be used to deliver Virtual Desktop Infrastructure (VDI) desktops (desktops running single-session OSs that can optionally be personalized), virtual machine (VM)-hosted apps (applications from single-session OSs), and hosted physical desktops. Only one user at a time can connect to each of these desktops. A Remote PC access machine may enable remote users to access their physical office PCs from any device running the resource access application 624.

Delivery Groups may specify which users can access which applications and/or desktops on which machines. Delivery Groups may include machines from the Machine Catalogs, and Active Directory users who have access to the Site. In some implementations, users may be assigned to Delivery Groups by their Active Directory group, because Active Directory groups and Delivery Groups are ways to group users with similar requirements.

Delivery Groups may contain machines from more than one Machine Catalog, and Machine Catalogs may contribute machines to more than one Delivery Group. In at least some implementations, however, individual machines can only belong to one Delivery Group at a time.

The specific resources that users in the Delivery Group can access may be defined. For example, to deliver different applications to different users, all of the applications may be installed on the master image for one Machine Catalog and enough machines may be created in that catalog to distribute among several Delivery Groups. Delivery Groups may then be configured to deliver a different subset of applications that are installed on the machines.

Application Groups may provide application management and resource control advantages over using more Delivery Groups. Using a “tag restriction” feature, existing machines may be used for more than one “publishing” task, saving the costs of deployment and managing additional machines. A tag restriction can be thought of as subdividing (or partitioning) the machines in a Delivery Group. Application Groups may also be helpful when isolating and troubleshooting a subset of machines in a Delivery Group.

“Tags” may be strings that identify items such as machines, applications, desktops, Delivery Groups, Application Groups, and policies. After creating a tag and adding it to an item, certain operations may be tailored to apply to only items that have a specified tag.

In some implementations, tags may be used to tailor search displays is the resource manager 614. For example, to display only applications that have been optimized for testers, a tag named “test” may be created and may then be added (applied) to those applications. A search performed by the resource manager 614 may then be filtered with the tag “test”.

In some implementations, tags may be used to “publish” applications from an Application Group or specific desktops from a Delivery Group, considering only a subset of the machines in selected Delivery Groups. Using an Application Group or desktops with a tag restriction may be helpful when isolating and troubleshooting a subset of machines in a Delivery Group.

In some implementations, tags may be used to schedule periodic restarts for a subset of machines in a Delivery Group. Using a tag restriction for machines may, for example, enable the use of new PowerShell cmdlets to configure multiple restart schedules for subsets of machines in a Delivery Group.

In some implementations, tags may be used to tailor the application (assignment) of particular policies to a subset of machines in Delivery Groups, Delivery Group types, or organizational units (OUs) of a Site that have (or do not have) a specified tag. For example, if a particular policy is to be applied only to the more powerful workstations, a tag named “high power” may be applied to those machines and the policy may be set to apply to only machines to which the high power tag has been applied. Tags may additionally or alternatively be applied to particular Delivery Groups and one or more policies may be set to apply only the Delivery Groups to which such tags have been applied.

In some embodiments, the resource manager 614 may be used to create or edit a tag restriction for a desktop in a shared Delivery Group or an Application Group. In some implementations, creating such a tag restriction may involve several steps. First, a tag may be created and then added (applied) to one or more machines. Second a group may be created or edited to include the tag restriction, thus restricting launches to machines with the applied tag. A tag restriction may extend the machine selection process of the broker service 632. In particular, the broker service 632 may select a machine from an associated Delivery Group subject to access policy, configured user lists, zone preference, and launch readiness, plus the tag restriction (if present). For applications, the broker service 632 may fall back to other Delivery Groups in priority order, applying the same machine selection rules for each considered Delivery Group.

As noted above, the resource delivery system 600 described in connection with FIGS. 6A-6D may provide virtualization solutions that give administrators control of virtual machines, applications, and security while providing anywhere access for any device. As was also noted above, the resource delivery system 600 may also enable end users to access applications and desktops independently of the operating systems and interfaces of the client devices 202 such end users are operating.

In some implementations, one or more components of the resource delivery system 600 may be provided as a service within a cloud-based computing environment. FIG. 6E illustrates an example of such an implementation. As shown in FIG. 6E, one or more cloud connectors 668 may enable various resources at one or more locations 670 outside of a cloud computing environment 672 to interface with various components within the cloud computing environment 672. As illustrated, resource location(s) 670 may include the machines and other resources that deliver applications and/or desktops to client devices 202. As indicated by dashed lines, the resource location 670 may optionally include the gateway 608 and/or the client access manager 610 previously described. In the illustrated example, the resource delivery controller(s) 612, the resource manager 614, the resource director 616, the license manager 618, and the database(s) 620 are all provided within the cloud computing environment 672. Further, as shown in FIG. 6E, a configuration manager 674 may additionally be hosted within the cloud computing environment 672 in some implementations. Examples of management functions that may be performed by the configuration manager 674 are described below. In some implementations, the cloud computing environment 672 may correspond to a public cloud computing infrastructure, such as AZURE CLOUD provided by Microsoft Corporation of Redmond, Washington, or AMAZON WEB SERVICES provided by Amazon.com, Inc., of Seattle, Washington.

In addition to serving as a channel for communication between the cloud computing environment 672 and the resource location(s) 670, the cloud connectors 668 may enable cloud management without requiring any complex networking or infrastructure configuration such as virtual private networks (VPNs) or Internet Protocol Security (IPsec) tunnels.

As noted above, the resource delivery controller(s) 612 may serve as the central control layer component in a deployment. The resource delivery controller(s) 612 may communicate through the cloud connectors 668 in each resource location 670 to distribute applications and/or desktops, authenticate and manage user access, broker connections between users and their virtual desktops and/or applications, optimize use connections, and/or load-balance use connections. In some implementations, the resource delivery controller(s) 612 may additionally track which users are logged on and where, which session resources the users have, and if users need to reconnect to existing applications. The resource delivery controller(s) 612 may further manage the state of desktops, starting and stopping them based on demand and administrative configuration, in some implementations.

The configuration manager 674 in the cloud computing environment 672 may (A) enable administrators to specify which services are to be made available to users via the resource access application, (B) customize the uniform resource locator (URL) that the resource access application 624 is to use to access the available resources, (C) customize the appearance of the user interface provided by the resource access application, such as logos, color, and preferences, (D) specify how users are to authenticate to the system, such as using the Active Directory 622, and/or (E) specify external connectivity for the resource locations 670.

As noted above, a resource location 670 may include at least one cloud connector 668 that serves as the communications channel between the components in the cloud computing environment 672 and the components in the resource location 670. In the resource location 670, the cloud connector(s) may act as a proxy for the resource delivery controller(s) 612 in the cloud computing environment 672.

As noted above, the physical or virtual machines that deliver applications and/or desktops may include resource delivery agents 604a, 604b. The resource delivery agents 604 may register with at least one cloud connector 668. After registration, connections may be brokered from those resources to users. The resource delivery agents 604 may further establish and manage the connection between the machine and the client device 202, and apply policies that are configured for the session. The resource delivery agents 604 may communicate session information to the cloud connector 668 through the broker agent 656 (shown in FIG. 6D) in the resource delivery agent 604. As noted above, in some implementations, such a broker agent 656 may host multiple plugins and collect real-time data.

A host connection may be established that enables communication between components in the cloud computing environment 672 and the resource delivery agents 604 on the shared computing resources 602. Specifications for such host connections may include (A) the address and credentials to access the host, (B) the tool that is to be used to create VMs, (C) the storage method to use, (D) the machines to use for storage, and/or (E) which network the VMs will use.

### G. Systems and Methods for Providing File Sharing Over Network(s)

FIG. 7A shows an example network environment 700 for allowing an authorized client 202a and/or an unauthorized client 202b to upload a file 702 to a file sharing system 704 or download a file 702 from the file sharing system 704. The authorized client 202a may, for example, be a client 202 operated by a user having an active account with the file sharing system 704, while the unauthorized client 202b may be operated by a user who lacks such an account. As shown, in some embodiments, the authorized client 202a may include a file management application 713 with which a user of the authorized client 202a may access and/or manage the accessibility of one or more files 702 via the file sharing system 704. The file management application 713 may, for example, be a mobile or desktop application installed on the authorized client 202a (or in a computing environment accessible by the authorized client). The ShareFile© mobile app and the ShareFile© desktop app offered by Citrix Systems, Inc., of Fort Lauderdale, FL, are examples of such preinstalled applications. In other embodiments, rather than being installed on the authorized client 202a, the file management application 713 may be executed by a web server (included with the file sharing system 704 or elsewhere) and provided to the authorized client 202a via one or more web pages.

As FIG. 7A illustrates, in some embodiments, the file sharing system 704 may include an access management system 706 and a storage system 708. As shown, the access management system 706 may include one or more access management servers 204a and a database 710, and the storage system 708 may include one or more storage control servers 204b and a storage medium 712. In some embodiments, the access management server(s) 204a may, for example, allow a user of the file management application 713 to log in to his or her account, e.g., by entering a user name and password corresponding to account data stored in the database 710. Once the user of the client 202a has logged in, the access management server 204a may enable the user to view (via the authorized client 202a) information identifying various folders represented in the storage medium 712, which is managed by the storage control server(s) 204b, as well as any files 702 contained within such folders. File/folder metadata stored in the database 710 may be used to identify the files 702 and folders in the storage medium 712 to which a particular user has been provided access rights.

In some embodiments, the clients 202a, 202b may be connected to one or more networks 206a (which may include the Internet), the access management server(s) 204a may include webservers, and an appliance 208a may load balance requests from the authorized client 202a to such webservers. The database 710 associated with the access management server(s) 204a may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202a, 202b are shown is FIG. 7A as stand-alone computers, it should be appreciated that one or both of the clients 202a, 202b shown in FIG. 7A may instead represent other types of computing devices or systems that can be operated by users. In some embodiments, for example, one or both of the authorized client 202a and the unauthorized client 202b may be implemented as a server-based virtual computing environment that can be remotely accessed using a separate computing device operated by users, such as described above.

In some embodiments, the access management system 706 may be logically separated from the storage system 708, such that files 702 and other data that are transferred between clients 202 and the storage system 708 do not pass through the access management system 706. Similar to the access management server(s) 204a, one or more appliances 208b may load-balance requests from the clients 202a, 202b received from the network(s) 206a (which may include the Internet) to the storage control server(s) 204b. In some embodiments, the storage control server(s) 204b and/or the storage medium 712 may be hosted by a cloud-based service provider (e.g., Amazon Web Services™ or Microsoft Azure™). In other embodiments, the storage control server(s) 204b and/or the storage medium 712 may be located at a data center managed by an enterprise of a client 202, or may be distributed among some combination of a cloud-based system and an enterprise system, or elsewhere.

After a user of the authorized client 202a has properly logged in to an access management server 204a, the server 204a may receive a request from the client 202a for access to one of the files 702 or folders to which the logged in user has access rights. The request may either be for the authorized client 202a to itself to obtain access to a file 702 or folder or to provide such access to the unauthorized client 202b. In some embodiments, in response to receiving an access request from an authorized client 202a, the access management server 204a may communicate with the storage control server(s) 204b (e.g., either over the Internet via appliances 208a and 208b or via an appliance 208c positioned between networks 206b and 206c) to obtain a token generated by the storage control server 204b that can subsequently be used to access the identified file 702 or folder.

In some implementations, the generated token may, for example, be sent to the authorized client 202a, and the authorized client 202a may then send a request for a file 702, including the token, to the storage control server(s) 202b. In other implementations, the authorized client 202a may send the generated token to the unauthorized client 202b so as to allow the unauthorized client 202b to send a request for the file 702, including the token, to the storage control server(s) 204b. In yet other implementations, an access management server 204a may, at the direction of the authorized client 202a, send the generated token directly to the unauthorized client 202b so as to allow the unauthorized client 202b to send a request for the file 702, including the token, to the storage control server(s) 204b. In any of the forgoing scenarios, the request sent to the storage control server(s) 204b may, in some embodiments, include a uniform resource locator (URL) that resolves to an internet protocol (IP) address of the storage control server(s) 204b, and the token may be appended to or otherwise accompany the URL. Accordingly, providing access to one or more clients 202 may be accomplished, for example, by causing the authorized client 202a to send a request to the URL address, or by sending an email, text message or other communication including the token-containing URL to the unauthorized client 202b, either directly from the access management server(s) 204a or indirectly from the access management server(s) 204a to the authorized client 202a and then from the authorized client 202a to the unauthorized client 202b. In some embodiments, selecting the URL or a user interface element corresponding to the URL, may cause a request to be sent to the storage control server(s) 204b that either causes a file 702 to be downloaded immediately to the client that sent the request, or may cause the storage control server 204b to return a webpage to the client that includes a link or other user interface element that can be selected to effect the download.

In some embodiments, a generated token can be used in a similar manner to allow either an authorized client 202a or an unauthorized client 202b to upload a file 702 to a folder corresponding to the token. In some embodiments, for example, an “upload” token can be generated as discussed above when an authorized client 202a is logged in and a designated folder is selected for uploading. Such a selection may, for example, cause a request to be sent to the access management server(s) 204a, and a webpage may be returned, along with the generated token, that permits the user to drag and drop one or more files 702 into a designated region and then select a user interface element to effect the upload. The resulting communication to the storage control server(s) 204b may include both the to-be-uploaded file(s) 702 and the pertinent token. On receipt of the communication, a storage control server 204b may cause the file(s) 702 to be stored in a folder corresponding to the token.

In some embodiments, sending a request including such a token to the storage control server(s) 204b (e.g., by selecting a URL or user interface element included in an email inviting the user to upload one or more files 702 to the file sharing system 704), a webpage may be returned that permits the user to drag and drop one or more files 702 into a designated region and then select a user interface element to effect the upload. The resulting communication to the storage control server(s) 204b may include both the to-be-uploaded file(s) 702 and the pertinent token. On receipt of the communication, a storage control server 204b may cause the file(s) 702 to be stored in a folder corresponding to the token.

In the described embodiments, the clients 202, servers 204, and appliances 208 and/or 212 (appliances 212 are shown in FIG. 2) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may correspond to respective computing systems, groups of computing systems, or networks of distributed computing systems, such as computing system 300 shown in FIG. 3.

As discussed above in connection with FIG. 7A, in some embodiments, a file sharing system may be distributed between two sub-systems, with one subsystem (e.g., the access management system 706) being responsible for controlling access to files 702 stored in the other subsystem (e.g., the storage system 708). FIG. 7B illustrates conceptually how one or more clients 202 may interact with two such subsystems.

As shown in FIG. 7B, an authorized user operating a client 202, which may take on any of numerous forms, may log in to the access management system 706, for example, by entering a valid user name and password. In some embodiments, the access management system 706 may include one or more webservers that respond to requests from the client 202. The access management system 706 may store metadata concerning the identity and arrangements of files 702 (shown in FIG. 7A) stored by the storage system 708, such as folders maintained by the storage system 708 and any files 702 contained within such folders. In some embodiments, the metadata may also include permission metadata identifying the folders and files 702 that respective users are allowed to access. Once logged in, a user may employ a user interface mechanism of the client 202 to navigate among folders for which the metadata indicates the user has access permission.

In some embodiments, the logged-in user may select a particular file 702 the user wants to access and/or to which the logged-in user wants a different user of a different client 202 to be able to access. Upon receiving such a selection from a client 202, the access management system 706 may take steps to authorize access to the selected file 702 by the logged-in client 202 and/or the different client 202. In some embodiments, for example, the access management system 706 may interact with the storage system 708 to obtain a unique “download” token which may subsequently be used by a client 202 to retrieve the identified file 702 from the storage system 708. The access management system 706 may, for example, send the download token to the logged-in client 202 and/or a client 202 operated by a different user. In some embodiments, the download token may a single-use token that expires after its first use.

In some embodiments, the storage system 708 may also include one or more webservers and may respond to requests from clients 202. In such embodiments, one or more files 702 may be transferred from the storage system 708 to a client 202 in response to a request that includes the download token. In some embodiments, for example, the download token may be appended to a URL that resolves to an IP address of the webserver(s) of the storage system 708. Access to a given file 702 may thus, for example, be enabled by a “download link” that includes the URL/token. Such a download link may, for example, be sent the logged-in client 202 in the form of a “DOWNLOAD” button or other user interface element the user can select to effect the transfer of the file 702 from the storage system 708 to the client 202. Alternatively, the download link may be sent to a different client 202 operated by an individual with which the logged-in user desires to share the file 702. For example, in some embodiments, the access management system 706 may send an email or other message to the different client 202 that includes the download link in the form of a “DOWNLOAD” button or other user interface element, or simply with a message indicating “Click Here to Download” or the like. In yet other embodiments, the logged-in client 202 may receive the download link from the access management system 706 and cut-and-paste or otherwise copy the download link into an email or other message the logged in user can then send to the other client 202 to enable the other client 202 to retrieve the file 702 from the storage system 708.

In some embodiments, a logged-in user may select a folder on the file sharing system to which the user wants to transfer one or more files 702 (shown in FIG. 7A) from the logged-in client 202, or to which the logged-in user wants to allow a different user of a different client 202 to transfer one or more files 702. Additionally or alternatively, the logged-in user may identify one or more different users (e.g., by entering their email addresses) the logged-in user wants to be able to access one or more files 702 currently accessible to the logged-in client 202.

Similar to the file downloading process described above, upon receiving such a selection from a client 202, the access management system 706 may take steps to authorize access to the selected folder by the logged-in client 202 and/or the different client 202. In some embodiments, for example, the access management system 706 may interact with the storage system 708 to obtain a unique “upload token” which may subsequently be used by a client 202 to transfer one or more files 702 from the client 202 to the storage system 708. The access management system 706 may, for example, send the upload token to the logged-in client 202 and/or a client 202 operated by a different user.

One or more files 702 may be transferred from a client 202 to the storage system 708 in response to a request that includes the upload token. In some embodiments, for example, the upload token may be appended to a URL that resolves to an IP address of the webserver(s) of the storage system 708. For example, in some embodiments, in response to a logged-in user selecting a folder to which the user desires to transfer one or more files 702 and/or identifying one or more intended recipients of such files 702, the access management system 706 may return a webpage requesting that the user drag-and-drop or otherwise identify the file(s) 702 the user desires to transfer to the selected folder and/or a designated recipient. The returned webpage may also include an “upload link,” e.g., in the form of an “UPLOAD” button or other user interface element that the user can select to effect the transfer of the file(s) 702 from the client 202 to the storage system 708.

In some embodiments, in response to a logged-in user selecting a folder to which the user wants to enable a different client 202 operated by a different user to transfer one or more files 702, the access management system 706 may generate an upload link that may be sent to the different client 202. For example, in some embodiments, the access management system 706 may send an email or other message to the different client 202 that includes a message indicating that the different user has been authorized to transfer one or more files 702 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 702 the different user wishes to upload to the file sharing system 704. The returned webpage may also include a user interface element, e.g., in the form of an “UPLOAD” button, that the different user can select to effect the transfer of the file(s) 702 from the client 202 to the storage system 708. In other embodiments, the logged-in user may receive the upload link from the access management system 706 and may cut-and-paste or otherwise copy the upload link into an email or other message the logged-in user can then send to the different client 202 to enable the different client to upload one or more files 702 to the storage system 708.

In some embodiments, in response to one or more files 702 being uploaded to a folder, the storage system 708 may send a message to the access management system 706 indicating that the file(s) 702 have been successfully uploaded, and an access management system 706 may, in turn, send an email or other message to one or more users indicating the same. For user's that have accounts with the file sharing system 704, for example, a message may be sent to the account holder that includes a download link that the account holder can select to effect the transfer of the file 702 from the storage system 708 to the client 202 operated by the account holder. Alternatively, the message to the account holder may include a link to a webpage from the access management system 706 inviting the account holder to log in to retrieve the transferred files 702. Likewise, in circumstances in which a logged-in user identifies one or more intended recipients for one or more to-be-uploaded files 702 (e.g., by entering their email addresses), the access management system 706 may send a message including a download link to the designated recipients (e.g., in the manner described above), which such designated recipients can then use to effect the transfer of the file(s) 702 from the storage system 708 to the client(s) 202 operated by those designated recipients.

FIG. 7C is a block diagram showing an example of a process for generating access tokens (e.g., the upload tokens and download tokens discussed above) within the file sharing system 704 described in connection with FIGS. 7A and 7B.

As shown, in some embodiments, a logged-in client 202 may initiate the access token generation process by sending an access request 714 to the access management server(s) 204b. As noted above, the access request 714 may, for example, correspond to one or more of (A) a request to enable the downloading of one or more files 702 (shown in FIG. 7A) from the storage system 708 to the logged-in client 202, (B) a request to enable the downloading of one or more files 702 from the storage system 708 to a different client 202 operated by a different user, (C) a request to enable the uploading of one or more files 702 from a logged-in client 202 to a folder on the storage system 708, (D) a request to enable the uploading of one or more files 702 from a different client 202 operated by a different user to a folder of the storage system 708, (E) a request to enable the transfer of one or more files 702, via the storage system 708, from a logged-in client 202 to a different client 202 operated by a different user, or (F) a request to enable the transfer of one or more files 702, via the storage system 708, from a different client 202 operated by a different user to a logged-in client 202.

In response to receiving the access request 714, an access management server 204a may send a “prepare” message 716 to the storage control server(s) 204b of the storage system 708, identifying the type of action indicated in the request, as well as the identity and/or location within the storage medium 712 of any applicable folders and/or files 702. As shown, in some embodiments, a trust relationship may be established (step 718) between the storage control server(s) 204b and the access management server(s) 204a. In some embodiments, for example, the storage control server(s) 204b may establish the trust relationship by validating a hash-based message authentication code (HMAC) based on shared secret or key 730).

After the trust relationship has been established, the storage control server(s) 204b may generate and send (step 720) to the access management server(s) 204a a unique upload token and/or a unique download token, such as those as discussed above.

After the access management server(s) 204a receive a token from the storage control server(s) 204b, the access management server(s) 204a may prepare and send a link 722 including the token to one or more client(s) 202. In some embodiments, for example, the link may contain a fully qualified domain name (FQDN) of the storage control server(s) 204b, together with the token. As discussed above, the link 722 may be sent to the logged-in client 202 and/or to a different client 202 operated by a different user, depending on the operation that was indicated by the request.

The client(s) 202 that receive the token may thereafter send a request 724 (which includes the token) to the storage control server(s) 204b. In response to receiving the request, the storage control server(s) 204b may validate (step 726) the token and, if the validation is successful, the storage control server(s) 204b may interact with the client(s) 202 to effect the transfer (step 728) of the pertinent file(s) 702, as discussed above.

### H. Example Architecture of a Resource Virtualization Server

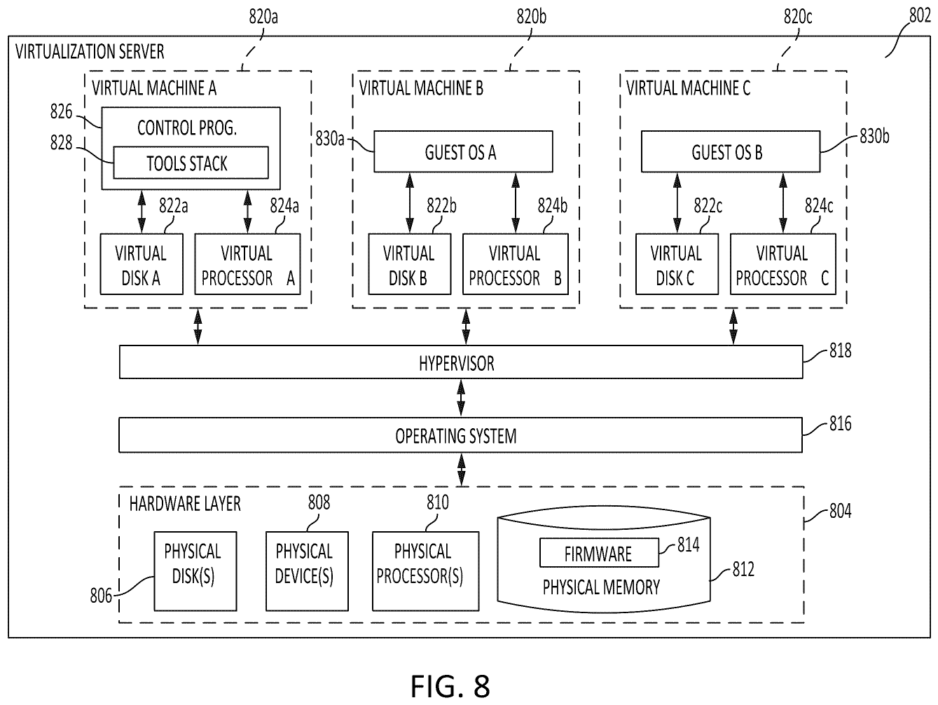

FIG. 8 shows an example architecture of an illustrative resource virtualization server 802. As shown, the resource virtualization server 802 may be configured to provide virtual desktops and/or virtual applications to one or more client access devices, such as the clients 202. As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Instances of the operating system may be physical (e.g., one operating system per physical device) or virtual (e.g., many instances of an OS running on a single physical device). The applications may be executed on a local device, or executed on a remotely located device (e.g., remoted).

The virtualization server 802 illustrated in FIG. 8 may be deployed as and/or implemented by one or more of the servers 204 described above, the servers that make up a virtualization server system, or by other known computing devices. Included in the virtualization server 802 is a hardware layer 804 that may include one or more physical disks 806, one or more physical devices 808, one or more physical processors 810, and one or more physical memories 812. In some embodiments, firmware 814 may be stored within a memory element in physical memory 812 and be executed by one or more of the physical processors 810. The virtualization server 802 may further include an operating system 816 that may be stored in a memory element in physical memory 812 and executed by one or more of physical processors 810. Still further, a hypervisor 818 may be stored in a memory element in the physical memory 812 and be executed by one or more of the physical processors 810. Presence of the operating system 816 may be optional such as in a case where the hypervisor 818 is a Type 1 hypervisor; that is, a bare-metal hypervisor installed directly on the hardware layer 804. In some implementations, the hypervisor 818 may be a Type 2 hypervisor, which executes on a host operating system, such as the OS 816, which may provide virtualization services such as I/O device support and memory management.

Executing on one or more of the physical processors 810 may be one or more virtual machines 820a-c (generally 820). The virtual machines 820 may have respective virtual disks 822a-c and virtual processors 824a-c. In some embodiments, a first virtual machine 820a may execute, using the virtual processor 824a, a control program 826 that includes a tools stack 828. The control program 826 may be referred to as a control virtual machine, Domain 0, Dom0, or other virtual machine used for system administration and/or control. In some embodiments, one or more of the virtual machines 820b-c may execute, using a virtual processor 824b-c, a guest operating system 830a-b (generally 830).

The physical devices 808 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 802. The physical memory 812 in hardware layer 804 may include any type of memory. The physical memory 812 may store data, and in some embodiments may store one or more programs, or set of executable instructions. FIG. 8 illustrates an embodiment where firmware 814 is stored within physical memory 812 of virtualization server 802. Programs or executable instructions stored in physical memory 812 may be executed by the one or more of the processors 810 of the virtualization server 802.

The virtualization server 802 may also include hypervisor 818. In some embodiments, the hypervisor 818 may be a program executed by processors 810 on the virtualization server 802 to create and manage any number of virtual machines 820. The hypervisor 818 may be referred to as a virtual machine monitor, or platform virtualization software. In some embodiments, the hypervisor 818 may be any combination of executable instructions and hardware that monitors virtual machines 820 executing on a computing machine. The hypervisor 818 may be a Type 2 hypervisor, where the hypervisor executes within operating system 816 executing on virtualization server 802. The virtual machines may then execute at a layer above hypervisor 818. In some embodiments, the Type 2 hypervisor may execute within the context of a user's operating system such that the Type 2 hypervisor interacts with the user's operating system. In other embodiments, one or more virtualization servers 802 in a virtualization environment may instead include a Type 1 hypervisor (not shown). A Type 1 hypervisor may execute on the virtualization server 802 by directly accessing the hardware and resources within hardware layer 804. That is, while the Type 2 hypervisor 818 accesses system resources through host operating system 816, as shown, a Type 1 hypervisor may directly access all system resources without host operating system 816. A Type 1 hypervisor may execute directly on one or more physical processors 810 of the virtualization server 802, and may include program data stored in the physical memory 812.

The hypervisor 818, in some embodiments, may provide virtual resources to the guest operating systems 830 or control programs 826 executing on virtual machines 820 in any manner that simulates the operating systems 830 or control programs 826 having direct access to system resources. System resources may include, but are not limited to, the physical devices 808, the physical disks 806, the physical processors 810, physical memory 812, and any other component included in the hardware layer 804 of the virtualization server 802. The hypervisor 818 may be used to emulate virtual hardware, partition physical hardware, virtualize physical hardware, and/or execute virtual machines that provide access to computing environments. In still other embodiments, the hypervisor 818 may control processor scheduling and memory partitioning for the virtual machine 820 executing on the virtualization server 802. Examples of hypervisor 818 may include those manufactured by VMWare, Inc., of Palo Alto, California; Xen Project® hypervisor, an open source product whose development is overseen by the open source XenProject.org community; Hyper-V®, Virtual Server®, and Virtual PC® hypervisors provided by Microsoft Corporation of Redmond, Washington; or others. In some embodiments, the virtualization server 802 may execute a hypervisor 818 that creates a virtual machine platform on which the guest operating systems 830 may execute. In these embodiments, the virtualization server 802 may be referred to as a host server. An example of such a virtualization server is Citrix Hypervisor® provided by Citrix Systems, Inc., of Fort Lauderdale, Florida.

The hypervisor 818 may create one or more virtual machines 820b-c (generally 820) in which guest operating systems 830 execute. In some embodiments, the hypervisor 818 may load a virtual machine image to create a virtual machine 820. The virtual machine image may refer to a collection of data, states, instructions, etc., that make up an instance of a virtual machine. In other embodiments, the hypervisor 818 may execute guest operating system 830 within the virtual machine 820. In still other embodiments, the virtual machine 820 may execute the guest operating system 830.

In addition to creating the virtual machines 820, the hypervisor 818 may control the execution of at least one virtual machine 820. In other embodiments, the hypervisor 818 may present at least one virtual machine 820 with an abstraction of at least one hardware resource provided by the virtualization server 802 (e.g., any hardware resource available within hardware layer 804). In other embodiments, the hypervisor 818 may control the manner in which the virtual machines 820 access physical processors 810 available in the virtualization server 802. Controlling access to the physical processors 810 may include determining whether the virtual machine 820 should have access to the processor 810, and how physical processor capabilities are presented to the virtual machine 820.

As shown in FIG. 8, the virtualization server 802 may host or execute one or more virtual machines 820. A virtual machine 820 may be a set of executable instructions and/or user data that, when executed by processor 810, may imitate the operation of a physical computer such that the virtual machine 820 may execute programs and processes much like a physical computing device. While FIG. 8 illustrates an embodiment where the virtualization server 802 hosts three virtual machines 820, in other embodiments the virtualization server 802 may host any number of virtual machines 820. The hypervisor 818, in some embodiments, may provide the virtual machines 820 with unique virtual views of the physical hardware, including the memory 812, the processor 810, and other system resources 806, 808 available to the respective virtual machines 820. In some embodiments, the unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, the hypervisor 818 may create one or more unsecure virtual machines 820 and one or more secure virtual machines 820. The unsecure virtual machines 820 may be prevented from accessing resources, hardware, memory locations, and programs that the secure virtual machines 820 may be permitted to access. In other embodiments, the hypervisor 818 may provide the virtual machines 820 with substantially similar virtual views of the physical hardware, memory, processor, and other system resources available to the virtual machines 820.

The virtual machines 820 may include respective virtual disks 822a-c (generally 822) and virtual processors 824a-c (generally 824.) The virtual disk 822, in some embodiments, may be a virtualized view of one or more physical disks 806 of the virtualization server 802, or a portion of one or more physical disks 806 of the virtualization server 802. The virtualized view of the physical disks 806 may be generated, provided, and managed by the hypervisor 818. In some embodiments, the hypervisor 818 may provide the virtual machines 820 with unique views of the physical disks 806. Thus, in these embodiments, a particular virtual disk 822 included in a respective virtual machine 820 may be unique when compared with other virtual disks 822.

The virtual processor 824 may be a virtualized view of one or more physical processors 810 of the virtualization server 802. In some embodiments, the virtualized view of physical processors 810 may be generated, provided, and managed by the hypervisor 818. In some embodiments, the virtual processor 824 may have substantially all of the same characteristics of at least one physical processor 810. In other embodiments, the virtual processor 810 may provide a modified view of the physical processors 810 such that at least some of the characteristics of the virtual processor 824 are different from the characteristics of the corresponding physical processor 810.

### I. Detailed Description of Example Embodiments of the System Providing Relevant Information During Video Playback Introduced in Section A

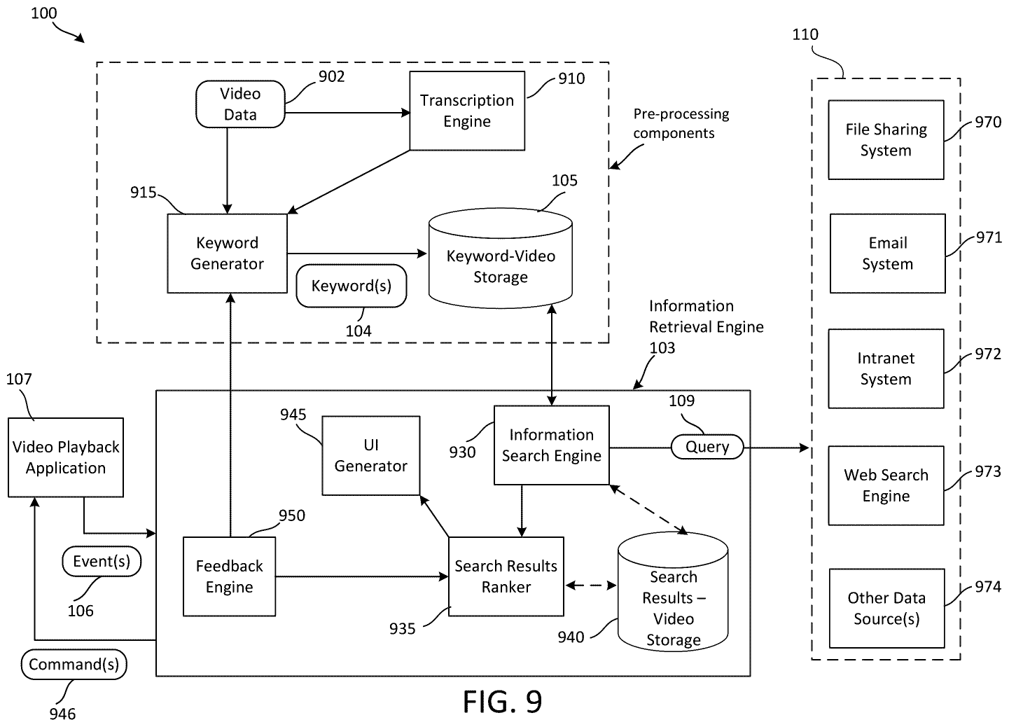

As described above in Section A, the present disclosure relates to providing relevant information to a user during video playback. As Section A explains with reference to FIG. 1, the computing system 100 may (A) store keyword(s) 104 corresponding to video contents, (B) receive an indication of playback of the video initiating, (C) in response to receiving the indication, retrieve the stored keyword(s) 104, (D) query the data source(s) 110 for information corresponding to the keyword(s) 104, and (E) cause a client device 202 to display of a representation of information 108 during the video playback. FIG. 9 is a block diagram illustrating example components that may be used to implement the functionalities described herein.

In some implementations, the computing system 100 shown in FIG. 9 may be implemented via one or more processors 302 described above (in Section C) in connection with FIG. 3, as well as one or more computer-readable mediums, such as non-volatile memory 306 described above (in Section C), that are encoded with instructions to be executed by the processor(s) 302. In some implementations, such instructions may cause the processor(s) 302 to implement one or more, or possibly all, of the operations of the computing system 100 described herein.

The components shown in FIG. 9 may be disposed at any of a number of locations within a computing network such as the network environment 200 described above (in Section B) in connection with FIG. 2. In some implementations, for example, the processor(s) and the computer-readable medium(s) embodying one or more of the components described herein may be located within one or more of the servers 204 and/or the computing system 300 that are described above (in Sections B and C) in connection with FIGS. 2 and 3, and/or may be located within a cloud computing environment 400 such as that described above (in Section D) in connection with FIG. 4.

As shown in FIG. 9, in some implementations, the computing system 100 may include a transcription engine 910, a keyword generator 915, and the keyword-video storage 105, which are sometimes collectively referred to herein as pre-processing components. As also shown in FIG. 9, and as described above in Section A in connection with FIG. 1, in some implementations, the computing system 100 may further include the video playback application 107, the information retrieval engine 103, and the data source(s) 110. As illustrated, the information retrieval engine 103, in some implementations, may include an information search engine 930, a search results ranker 935, a user interface (UI) generator 945, a feedback engine 950, and a search results-video storage 940. In some implementations, the information retrieval engine 103 may include the pre-processing components shown in FIG. 9. In other implementations, one or more of the components shown in FIG. 9 may be implemented in a different configuration, for example, fewer or more components may be included in the computing system 100 and/or the various components may be organized differently.

As described above in Section A, in example implementations, the video playback application 107 may be provided as part of the file sharing system 704 described above (in Section G) in connection with FIGS. 7A-7C. In such implementations, the video (e.g., video data 902) may be stored and made available via the file sharing system 704 (e.g., the video may be a file 702). In other example implementations, the video playback application 107 may be one of the SaaS applications 508 or other resources 504 accessed by the user 102 using the user interface of the resource access application 522. In such implementations, the video data 902 may be stored and made available by the multi-resource access system 500. In yet other example implementations, the video playback application 107 may be remotely accessed via one or more desktops and/or virtual applications using the resource access application 624. In such implementations, the video data 902 may be stored and made available by the resource delivery system 600. In yet other implementations, where the computing system 100 is a content provider service, the video data 902 may be stored at a storage medium of or in communication with the computing system 100.

As shown in FIG. 9, the computing system 100, in particular, the information search engine 930, may be in communication with the data sources 110. The various components shown in FIG. 9 may be in either wired or wireless communication with each other, e.g., via one or more networks, and may be in either direct or indirect communication with one another.

As shown in FIG. 9, the data sources 110 may include one or more different types of data sources, such as a file sharing system 970, an email system 971, an intranet system 972, a web search engine 973, and/or other data source(s) 974. The data sources 110 may include more than one instance of the foregoing different types of data sources. For example, the data sources 110 may include a first email system, a second email system, a first intranet system and a second intranet system, etc. Examples of other data source(s) 974 may include a collaboration tool/system, an online/web-based collaboration tool, a knowledge base, a corporate/internal wiki, a communication/messaging system, etc., accessible by the user 102 as being part of an organization (e.g., as an employee of a company). Non-limiting examples of the data sources 110 are Confluence, Backstage, Slack, Outlook, ShareFile, JIRA, shared network drives, etc.

In some implementations, the computing system 100 may use credentials of the user 102 (shown in FIG. 1), administrator credentials, or other authentication information to access and query the data source(s) 110. In some implementations, the computing system 100 may request the user 102 to provide such user credentials to establish communication with the data source(s) 110, and the data source(s) 110 may request the user 102 to approve communications with the computing system 100. In some implementations, the computing system 100 may use the mechanisms provided by the multi-resource access system 500 (described above in Section E), the resource delivery system 600 (described above in Section F), or the file sharing system 700 (described above in Section G) to gain access to the data source(s) 110.

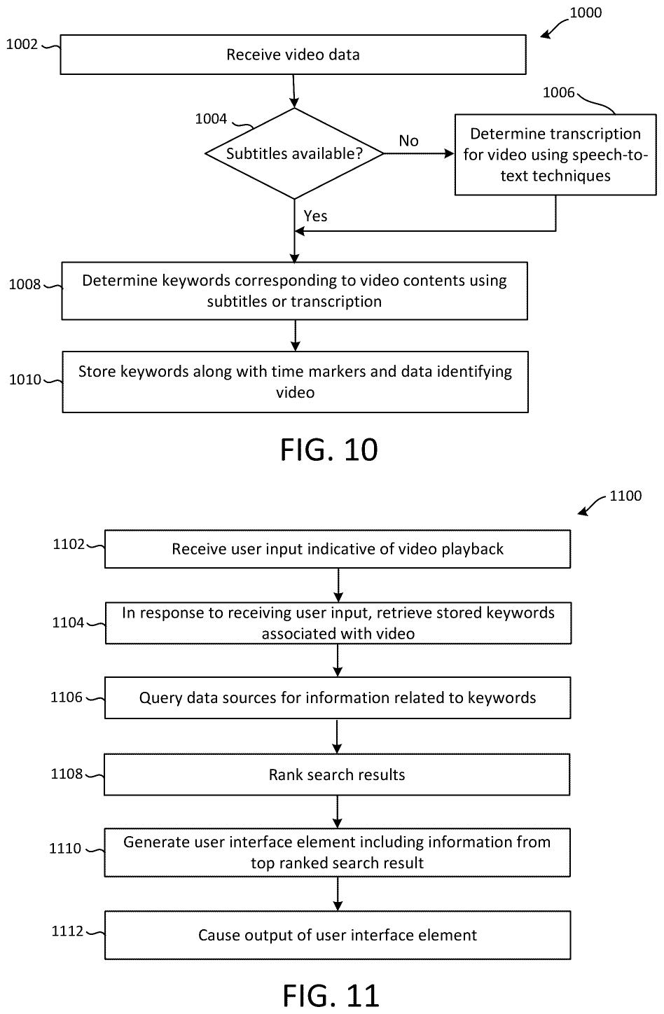

Functionalities performed by the components shown in FIG. 9 are described below in relation to the example routines shown in FIGS. 10-15. FIG. 10 shows an example routine 1000 that may be performed by the computing system 100 during pre-processing operations, where keywords corresponding to video contents may be determined and stored. Such pre-processing operations may provide a benefit by reducing the time it takes to provide relevant information to a user during video playback.

At a step 1002 of the routine 1000, the computing system 100 may receive video data 902, which may include a video and associated data (e.g., video title, video upload time, subtitles if available, and/or other metadata). In some cases, the video may be associated with subtitles, closed captions, etc., that represents a transcription of the video. In other cases, the video may not include subtitles.

At a decision 1004 of the routine 1000, the computing system 100 may determine whether subtitles are available for the video. If subtitles are available, the routine 1000 may proceed to a step 1008. If subtitles are not available, then, at a step 1006, the computing system 100, using the transcription engine 910, may determine a transcription for the video. The transcription engine 910 may be configured to employ speech-to-text techniques to determine the video transcription. In some implementations, the transcription engine 910 may employ one or more machine learning models (e.g., an acoustic model, a language model, a recurrent neural network (RNN), a RNN-transformer model, an encoder-decoder architecture, etc.).

At a step 1008 of the routine 1000, the computing system 100, using the keyword generator 915, may determine the keywords 104 corresponding to the video contents using the subtitles (included in the video data 902) or the transcription (generated by the transcription engine 910). The keyword generator 915 may employ one or more techniques to determine the keyword(s) 104 corresponding to the video contents. Example techniques may be natural language processing (NLP), natural language understanding (NLU), parts-of-speech (POS) tagging, keyword extraction, topic identification, grammar rules, etc. In some implementations, the keyword generator 915 may employ one or more machine learning models (e.g., neural networks, classifiers, Latent Dirichlet Allocation (LDA), Latent Semantic Analysis, Support Vector Machines, deep learning models, encoder-decoder architecture, hybrid models, etc.).

In some implementations, the keyword generator 915 may be configured to focus on certain words, such as proper nouns, which may represent terms that may be unfamiliar to a user. For example, rather than identifying a keyword that is a common noun (e.g., “software platform”) mentioned in the video, the keyword generator 915 may identify a keyword that is a proper noun (e.g., “Citrix Localization Platform”) mentioned in the video.

In some implementations, the keyword generator 915 may use more than just the subtitles/transcription to determine the keyword(s) 104. For example, the keyword generator 915 may use the metadata associated with the video and/or included in the video data 902 (e.g., video title, file tags, etc.). As another example, the keyword generator 915 may use information displayed during the video, rather than just the information that is spoken. Such displayed information may be extracted using techniques to recognize text from images/video frames.

In some implementations, the keyword generator 915 may be configured to identify keywords corresponding to terms, words, phrases, etc., that are specific to an organization that the user 102 may be part of (e.g., an employee of an organization).

In some implementations, the keyword generator 915 may determine keyword(s) corresponding to a duration of the video, and may associate the keyword(s) with a time marker identifying the duration of the video. For example, the keyword generator 915 may determine a first keyword corresponding to a first minute of the video, a second keyword corresponding to a second minute of the video, etc. In determining keywords for a duration of the video, the keyword generator 915 may process chunks of the video, where the individual chunks may include a portion (e.g., 30 seconds) prior to the instant portion and/or a portion (e.g., 30 seconds) after the instant portion, thus, using some context surrounding the instant portion to determine the keyword(s) for the instant portion.

At a step 1010 of the routine 1000, the keyword generator 915 may store the keyword(s) 104, along with time markers and data identifying the video, in the keyword-video storage 105. Storing the time markers along with the keywords 104 enables the computing system 100 to present information when the time marker is reached and video contents corresponding to a particular keyword is displayed in the video playback application 107.

FIG. 11 shows an example routine 1100 that may be performed by the computing system 100 to determine information corresponding to the keyword(s) 104 and presenting the information during video playback. At a step 1102, the computing system 100 may receive a user input indicative of video playback. The user 102 may provide the user input via the video playback application 107 using one or more user interface elements, speech inputs, etc. As an example, the user input may be selection of a “play” (or other similar functionality) button provided by the video playback application 107. In other examples, the user input may be selection of another functionality, such as “open”, “close”, “pause”, “restart”, “rewind”, “forward”, etc., any of which may be considered as an input indicative of video playback, and that may trigger querying of data sources and/or presentation of relevant information. The user 102 may also select the video to be played, for example, using a file management application, using the video playback application 107, clicking on an access link (e.g., provided by the file sharing system 700 as described in Section G above, provided by a website, provided by a content provider service, etc.), etc.

In some implementations, the video playback application 107 may send one or more events 106 to the information retrieval engine 103, where at least one such event 106 may be an indication that the playback of the video is initiated. The event 106 may be generated in respond to the video playback application 107 receiving the above-described input from the user 102. Examples of such an event 106 may be a PlayEvent( ), ButtonClickEvent( ), PauseEvent( ), RewindEvent( ), ForwardEvent( ), OpenVideoEvent( ), CloseVideoEvent( ), etc. The event 106 may include time marker information based on the portion of the video being actively presented, based on the length of the video, etc. For example, if the user 102 pauses the video after 1 minutes and 30 seconds have elapsed/has been played, then the time marker information may be the timestamp 1 mm:30 ss. In some implementations, an API may be used for communications between the video playback application 107 and the information retrieval engine 103, such as the communication of the events(s) 106 from the video playback application 107 to the information retrieval engine 103.

At a step 1104 of the routine 1100, in response to receiving the user input (at the step 1102), the computing system 100, using the information search engine 930, may retrieve the stored keyword(s) 104 associated with the video. In some implementations, the video playback application 107 may send a message or other type of indication notifying the information search engine 930 that a user input indicative of video playback is received. In some implementations, such communications (e.g., the event 106) may also include data identifying the video being played-back via the video playback application 107. The information search engine 930 may retrieve, from the keyword-video storage 105, the keyword(s) 104 associated with video being played-back via the video playback application 107.

At a step 1106 of the routine 1100, the information search engine 930 may query the data source(s) 110 for information related to the keyword(s) 104. The information search engine 930 may send a query 109 to one or more of the data sources 110. The information search engine 930 may generate the query 109 to include the keyword(s) 104, and send the generated query 109 to the data source 110. In response to receiving the query 109, the data source 110 may search its available data for information corresponding to the keyword(s) 104. The data source 110 may send one or more search results to the information search engine 930 in response to the query 109. If no search results are found, then the data source 110 may send an indication that no information was found. In some cases, the information search engine 930 may query the data sources 110 using an API request, possibly using access credentials associated with the user 102.

In some implementations, the information search engine 930 may query the data source(s) 110 for all the keywords 104 associated with the video. In other implementations, the information search engine 930 may query the data source(s) 110 for keyword(s) 104 associated with a particular (first) time marker (e.g., a time marker coming up during video playback), and may then at a later time separately query the data source(s) 110 for keyword(s) 104 associated with another (second) time marker that occurs after the first time marker.

In some cases, one or more of the data sources 110 may require user authentication to search its data. In some embodiments, the query request from the information search engine 930 may include user credentials, administrator credentials, or authorization tokens for the data source 110 to be searched. If authentication failed for the user 102 for the data source 110, then the data source 110 may not respond to the query request.

The search results received by the information search engine 930 from the data sources 110 may include multiple different types of data. For example, the file sharing system 970 may send data corresponding to one or more files (e.g., links to the files, the files themselves, filenames, summary/description of the files, etc.) that relate to the keyword(s) 104. As a further example, the email system 971 may send data corresponding to one or more emails (e.g., links to the emails, the email themselves, subject lines, sender and recipient information, etc.) that relate to the keyword(s) 104. As another example, the intranet system 972 may send data corresponding to webpages (e.g., links to the webpages, title of the webpages, summary/description of the webpages, tags for the webpages, etc.) that relate to the keyword(s) 104. As another example, the web search engine 973 may send data corresponding to publicly available websites (e.g., links to the websites, titles of the websites, summary/description of the websites, etc.).

At a step 1108 of the routine 1100, the computing system 100, using the search results ranker 935, may rank the search results received from the data source(s) 110. The information search engine 930 may send, to the search results ranker 935, the search results received from the data sources 110. The search results ranker 935 may rank, filter, prune, etc., the search results based on the respective search result's relevancy to the keyword(s) 104. In some implementations, the search results ranker 935 may use metadata (e.g., video title, video upload time, file tags, etc.) associated with the video (e.g., included in the video data 902) to rank the search results, such that the search results are not only related to the keyword(s) 104 but also relevant to the subject matter of the video.

In some implementations, the search results ranker 935 use information associated with the user 102 to rank the search results, such that the search results are optimized for the user 102. Such user information may include, for example, the user's level of experience (which may be indicated on a subject-matter basis), a job title/role, an amount of time the user 102 has been with the organization (e.g., new hire, employee of 1-year, employee of 5-years, etc.), an amount of time the user 102 has been part of a team, etc. Using such user-specific information the search results can be ranked to be relevant to the user's experience level, etc. For example, a search result providing basic information related to a keyword may be ranked higher for a new employee, while the same search result may be ranked lower for a user that has been with the organization for a number of years. The user information may be derived from a user profile that may be set up by or for the user 102 for the computing system 100, or may be derived from another system (e.g., an Active Directory for an organization). In other implementations, the user information may be derived from data stored by the multi-resource access system 500, the resource delivery system 600, the file sharing system 700, etc.

In some implementations, the search results ranker 935 may use information associated with an organization to rank the search results, such that the search results are relevant to the organization with which the user 102 is associated. The organization information may include, for example, an organization structure such as team names, business units, hierarchy of employee titles (e.g., VP, Manager, Sr. Manager, Associate, etc.), names of internal tools of the organization (e.g., HR platform, email system, etc.), etc. Using such organization information the search results can be ranked to be relevant to the organization. For example, a web search result providing information related to a keyword specific to the organization may be ranked lower, than an intranet search result providing information related to the same keyword. The organization information may be retrieved from a storage medium or another system (e.g., an Active Directory of the organization, an organization profile set up by an administrator of the organization, etc.). In other implementations, the organization information may be derived from data stored by the multi-resource access system 500, the resource delivery system 600, the file sharing system 700, etc.

The search results ranker 935 may employ one or more rule-based engines, machine learning model, statistical model, etc., that may be configured to determine a relevancy score for individual search results based on the keyword(s) 104, the video metadata, the user information and/or the organization information. In some implementations, the relevancy score may be based on a frequency of the keyword appearing in the search result, semantic similarity between the search result and the keyword, etc. The search results ranker 935 may determine a ranked list of search results to be presented to the user 102, for example, based on the corresponding relevancy score. The ranked list may include the top n scoring search results.

In some implementations, the search results ranker 935 may store the ranked list of search results in the search results-video storage 940 along with data identifying the video. In some implementations, the stored search results may be retrieved by the search results ranker 935 when a subsequent playback of the video is detected (e.g., another user 102 may provide an input initiating playback of the video), and may be used to present information during subsequent playback. The search results in the storage 940 may be updated so that the search results are more recent and up-to-date.

At a step 1110 of the routine 1100, the computing system 100, using the UI generator 945, may generate a user interface element including the information 108 from at least the top ranked search result (determined by the search results ranker 935). In some implementations, the search results ranker 935 may send the top ranked search result to the UI generator 945. In some implementations, the user interface element may be referred to as a “card” that includes information from the search result. The card may include a summary of the information from the search result. The user interface element may also include a hyperlink, a button, or other selectable user interface element, selection of which may direct the user 102 to the data source 110, and may enable the user 102 to view the information 108 (and additional information) at the data source 110.

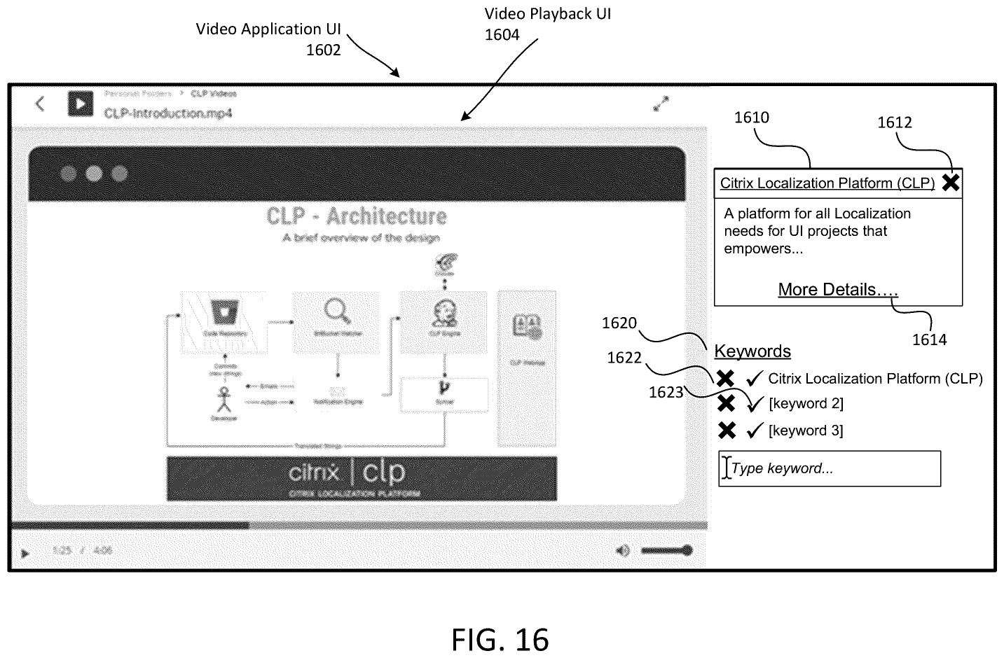

In some implementations, when the user 102 selects the selectable user interface element directing the user to the data source 110, the video playback application 107 may automatically pause playback of the video, and the data source 110 may be launched/opened in a separate screen/window for the user to view. In other implementations, the data source 110 may be presented via an overlay window presented on top of UI of the video playback application 107. When the user 102 closes or minimizes the data source window or otherwise returns to the UI of the video playback application 107, the video playback application 107 may automatically un-pause playback of the video. In this manner, the user 102 does not lose track of the video playback while viewing information at the data source. The information retrieval engine 103 may send a command 946 to the video playback application 107 to pause the video. In some implementations, the information retrieval engine 103 may receive an event (e.g., ButtonClickEvent( )) in response to the user 102 selecting the selectable user interface element (e.g., user interface element 1614 shown in FIG. 16). In response to receiving such an event, the computing system 100 may automatically pause the video playback.

At a step 1112 of the routine 1100, the computing system 100 may cause output of the user interface element. The user interface element, including the information 108, may be presented alongside the video, so that viewing of the video is uninhibited. In other implementations, the user interface element may be presented as an overlay over the video. The user interface element including the information 108 may, for example, be presented using an extension or plug-in of the video playback application 107. In some implementations, the information retrieval engine 103 may send a command 946 to the video playback application 107 to present the user interface element. In other implementations, the user interface element including the information 108 may be presented using another application that may present an overlay over the video playback application 107, or that may present the video playback application 107 in one sub-window and simultaneously present the user interface element including the information 108 in another, separate sub-window.

FIG. 16 illustrates an example video application user interface (UI) 1602 including a portion (e.g., video playback UI 1604) where the video is displayed, and another portion where the representation of the information 108 is displayed. The video application UI 1602 may be provided by the video playback application 107. The video playback UI 1604 may also provide user interface elements (e.g., a play button, a pause button, a volume button, etc.) to control playback of the video. As shown in FIG. 16, a user interface element (e.g., card) 1610 may include information corresponding to a keyword. The card 1610 may also include a selectable user interface element 1614, selection of which can direct the user 102 to the data source 110 associated with the information 108.

As the video continues to play, the user interface element including the information 108 may update. The search results ranker 935 (see FIG. 9) may send another search result, which corresponds to another keyword(s) 104 associated with another time marker, to the UI generator 945. The UI generator 945 may generate an additional user interface element, and may cause the video playback application 107 to display the additional user interface element. The additional user interface element may replace the initial user interface element or may be displayed in addition to the initial user interface element. In this manner, the information presented is updated to correspond to the contents of the video being actively viewed/presented in the video playback UI 1604. In some cases, if the user 102 rewinds the video, then previously presented information 108 may be presented again. To enable updating of the information 108 based on the video playback, the video playback application 107 may send an event 106 notifying the information retrieval engine 103 of user inputs (e.g., pause, play, rewind, forward, etc.) received with respect to video playback, and/or may send a time marker indicative of the portion of the video being presented in the video playback UI 1604.

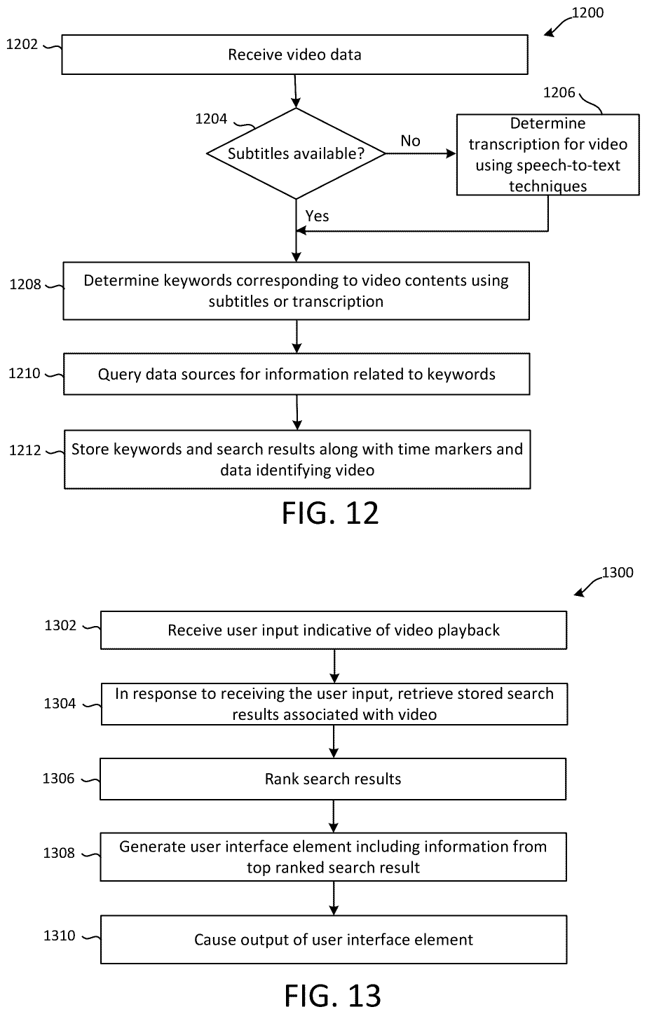

FIG. 12 shows another example routine 1200 that may be performed in another implementation by the computing system 100 as part of pre-processing operations. At a step 1202, the computing system 100 may receive the video data 902 (described above in relation to the routine 1000 of FIG. 10). At a decision 1204 of the routine 1200, the computing system 100 may determine whether subtitles for the video are available (in a similar manner as described above in relation to the routine 1000 of FIG. 10). If subtitles are available, then the routine may proceed to a step 1208. If subtitles are not available, then at a step 1206, the computing system 100, using the transcription engine 910 (described above in relation to the routine 1000 of FIG. 10), may determine a transcription for the video using speech-to-text recognition techniques.

At a step 1208 of the routine 1200, the computing system 100, using the keyword generator 915, may determine the keywords 104 corresponding to the video contents using the subtitles or the transcription. Details of the keyword generator 915 are described above in relation to FIG. 10.

At a step 1210 of the routine 1200, the computing system 100, using the information search engine 930, may query the data source(s) 110 for information related to keywords 104. Details of the information search engine 930 are described above in relation to FIG. 11 (e.g., the step 1106 of the routine 1100). As described above, the information search engine 930 may receive multiple search results from the data sources 110.

At a step 1212 of the routine 1200, the information search engine 930 may store the keywords 104 and the search results along with time markers and data identifying the video. As described above, certain keywords may relate to particular time markers of the video. The information search engine 930 may associate first keyword(s) 104 and corresponding search results with a time marker, so that when the video is played-back, the computing system 100 can present information corresponding to the individual time markers as the video progresses. In this manner, the routine 1200 relates to pre-processing video data to determine keywords and search results corresponding to the video contents.

FIG. 13 shows an example routine 1300 that may be performed in another implementation by the computing system 100 to present relevant information during video playback using the search results stored per the routine 1200. At a step 1302, the computing system 100 may receive a user input indicative of video playback (as described above in relation the routine 1100 of FIG. 11).

At a step 1304 of the routine 1300, in response to receiving the user input in step 1302, the computing system 100, using the information search engine 930, may retrieve, from the search results-video storage 940, the stored search results associated with the video. The information search engine 930 may send the stored search results to the search results ranker 935.

At a step 1306 of the routine 1300, the search results ranker 935 may rank the search results in a similar manner as described above in relation to the routine 1100 of FIG. 11. As such, the search results may be ranked based on video metadata, user information, organization information, etc. The search results ranker 935 may send the top ranked search result to the UI generator 945.

At a step 1308 of the routine 1300, the UI generator 945 may generate a user interface element including the information 108 from the top ranked search result (as described above in relation to the routine 1100 of FIG. 11). At a step 1310 of the routine 1300, the computing system 100 may cause output of the user interface element (as described above in relation to the routine 1100 of FIG. 11). In this manner, the computing system 100 may present relevant information during video playback using previously determined search results.

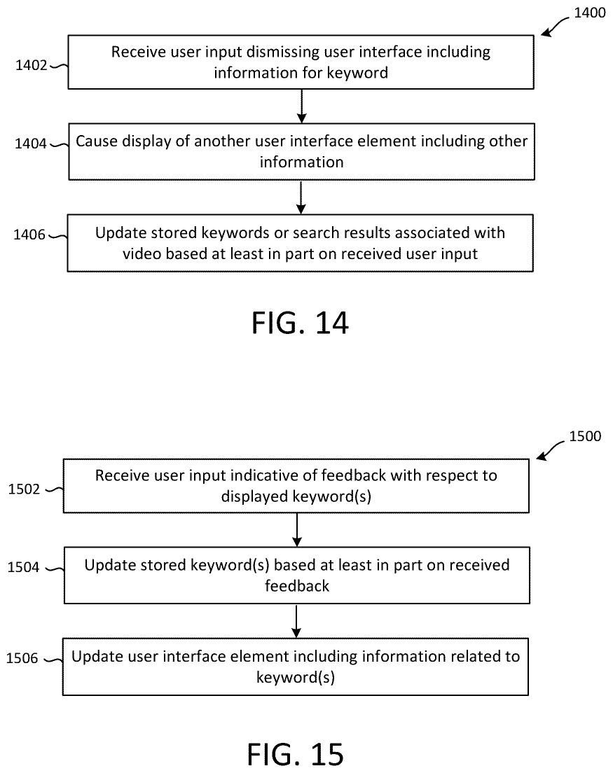

In some implementations, the user 102 can provide feedback with respect to the information 108 presented to the user 102 and/or the keywords. FIG. 14 shows an example routine 1400 that may be performed by the computing system 100 to receive user feedback with respect to the information 108 and update search results accordingly. At a step 1402 of the routine 1400, the computing system 100 may receive a user input dismissing the user interface element including the information 108 for the keyword 104. In some implementations, where the user interface element is presented using an extension or plug-in of the video playback application 107, the video playback application 107 may send, to the information retrieval engine 103, an event 106 in response to receiving the user input. In other implementations, where the other application may present the user interface element as an overlay or in a separate sub-window, the other application may send an event and/or data indicative of the user input dismissing the user interface element. Referring to FIG. 16, as shown, the card 1610 may include a user interface element 1612, selection of which may close/dismiss the card 1610. At the step 1402, the received user input may be the user 102 selecting the user interface element 1612.

At a step 1404 of the routine 1400, the computing system 100 may cause display of another user interface element including other information. For example, the search results ranker 935 may select the next/another search result from the top n list for the keyword corresponding to the initial search result from which information was presented, in case the user 102 did not like the top ranked search result. As another example, the search results ranker 935 may select a search result corresponding to another keyword associated with the time marker corresponding to the video playback, in case the user 102 did not want information for the initial keyword. The search results ranker 935 may send the selected search result to the UI generator 945, which in turn may generate the other user interface element including the other information. The generated user interface element may be presented as described above (e.g., by sending a command 946 to the video playback application 107 or another application to present this generated user interface element). In this manner, based on the user 102 dismissing presently displayed information 108, the computing system 100 may present (e.g., via another card 1610) information from another search result and/or information related to another keyword.

At a step 1406 of the routine 1400, the feedback engine 950 may update the stored keywords and/or search results associated with the video based at least in part on the received user input (of the step 1402). The feedback engine 950 may determine that the user 102 dismissing the user interface element including the information 108 is indicative of negative feedback with respect to the search result and/or the keyword. Based on this determination, the feedback engine 950 may send a message or other indication to the search results ranker 935, which may cause the search results ranker 935 to update the relevancy score associated with the search result (which may cause a re-ranking of the search results in the top n list) or to remove the search result from the top n list associated with the keyword 104. Additionally or alternatively, the search results ranker 935 may update the data and/or the mechanisms (e.g., a rules-based engine, a ML model, a statistical model, etc.) used to rank the search results.

Additionally or alternatively, the feedback engine 950 may send a message or other indication to the keyword generator 915, which may cause the keyword generator 915 to remove the keyword from the keywords 104 associated with the video or to update a score associated with the keyword. Additionally or alternatively, the keyword generator 915 may update the data and/or the mechanisms (e.g., a rules-based engine, a ML model, a statistical model, etc.) used to determine the keywords.

As described above in relation to FIG. 16, selection of the user interface element 1614 may direct the user 102 to the corresponding data source 110. In some implementations, the feedback engine 950 may determine positive feedback with respect to the information 108 based on the user 102 selecting the user interface element 1614. Based on determining receipt of positive feedback, the feedback engine 950 may cause the search results ranker 935 to update (e.g., increase) the relevancy score of the corresponding search result. Additionally or alternatively, the search results ranker 935 may update the data and/or the mechanisms used to rank the search results. Based on determining receipt of positive feedback, the feedback engine 950 may cause the keyword generator 915 to update (e.g., increase) the score of the corresponding keyword. Additionally or alternatively, the keyword generator 915 may update the data and/or the mechanisms used to determine the keywords.

FIG. 15 shows an example routine 1500 that may be performed by the computing system 100 to receive user feedback with respect to the keyword(s) 104 and update the keyword(s) accordingly. At a step 1502 of the routine 1500, the computing system 100 may receive a user input indicative of feedback with respect to displayed keyword(s) 104. Referring to FIG. 16, as shown therein, one or more keywords 1620 may be displayed alongside the video playback UI 1604 presenting the video. The displayed keywords 1620 may correspond to the current time maker of the video playback. In other cases, the displayed keywords 1620 may correspond to the entirety of the video. As shown in FIG. 16, selectable user interface elements (e.g., elements 1622, 1623) may be displayed along with the individual keywords. Selection of the user interface element 1622, by the user 102, may indicate negative feedback with respect to the corresponding keyword. Selection of the user interface element 1623, by the user 102, may indicate positive feedback with respect to the corresponding keyword. In some implementations, where the user interface element is presented using a plug-in or add-in of the video playback application 107, the video playback application 107 may send, to the information retrieval engine 103, an event 106 in response to receiving the user input. In other implementations, the other application presenting the user interface element as an overlay or within a separate sub-window, may send an event and/or data indicative of the user input/feedback.

At a step 1504 of the routine 1500, the feedback engine 950 may update the stored keyword(s) 104 based at least in part on the received feedback. The feedback engine 950 may send a message or other indication notifying the keyword generator 915 of the positive feedback or the negative feedback. Receipt of the feedback may cause the keyword generator 915 to remove the keyword from the keywords 104 associated with the video, update a score associated with the keyword, update the data and/or the mechanisms (e.g., a rules-based engine, a ML model, a statistical model, etc.) used to determine the keywords, etc.

At a step 1506 of the routine 1500, the computing system 100 may update the user interface element 1610 including the information 108 related to the keyword(s) 104. The feedback engine 950 may send a message or other indication notifying the search results ranker 935 of the positive feedback or the negative feedback. In case of negative feedback, the search results ranker 935 may select another search result corresponding to the keyword or select a search result corresponding to another keyword for presentation during the video playback. As described above in relation to step 1404 of the routine 1400, the search results ranker 935 may send the selected search result to the UI generator 945, which in turn may generate another user interface element 1610 for display. In response to receiving the feedback, the search results ranker 935 may update the relevancy score associated with the search result, may remove the search result from the top n list associated with the keyword 104, may update the data and/or the mechanisms (e.g., a rules-based engine, a ML model, a statistical model, etc.) used to rank the search results, etc.

Based on the feedback engine 950 causing updates to the keywords or the search results for the video, a subsequent playback of the video may cause presentation of different information than the instant video playback. In other words, feedback from the user 102 may affect the information presented to another user or during a subsequent playback by the same user.

In some implementations, the user 102 may provide another keyword, for example, via a text box shown under the keywords 1620 in FIG. 16. The user-provided keyword may cause updating of the stored keyword(s) 104, updating of the user interface elements currently presented to the user 102, etc. The information retrieval engine 103 may send a query 109 to the data source(s) 110 to retrieve search results corresponding to the user-provided keyword, may rank the retrieved search results, may generate a user interface element 1610 including information from one or more top ranked search results, and may cause output of the generated user interface element(s). In this manner, the user 102 may request the computing system 100 to present information related to a particular keyword of interest to the user 102 and relevant to the video. As described above, the search results ranker 935 may rank search results based on the video contents and a relevancy to the video.

As described above, FIG. 16 shows an example video application UI 1602 including the video playback UI 1604 and the user interface element 1610. Although FIG. 16 shows one user interface element 1610 (one card), it should be understood that multiple user interface elements 1610 (multiple cards) may be presented, where individual user interface elements 1610 may present information related to different keyword(s) 104 or may present different information related to the same keyword 104. In some implementations, the user interface elements 1610 may be ranked based on a ranking of the corresponding search results (as described above). Receipt of feedback with respect to the keywords 1620 may cause one or more of the user interface elements 1610 to update, disappear, re-order presentation of the user interface elements, etc.

J. Example Implementations of Methods, Systems, and Computer-Readable Media in Accordance with the Present Disclosure

The following paragraphs (M1) through (M8) describe examples of methods that may be implemented in accordance with the present disclosure.

(M1) A method may be performed that involves storing, in a storage medium, at least a first keyword corresponding to content of a video, after storing the first keyword, receiving, via a video playback application, an indication that playback of the video is initiated, in response to receipt of the indication, retrieving the first keyword from the storage medium, querying at least one data source for information corresponding to the first keyword, and causing a client device to display a representation of the information.

(M2) A method may be performed as described in paragraph (M1), and may further involve determining the first keyword corresponds to a time marker of the video, storing, in the storage medium, the first keyword and data identifying the time marker, determining, using the data identifying the time marker from the storage medium, that playback of the video is at a beginning of the time marker, and in response to determining that playback of the video is at a beginning of the time marker, causing the client device to display the representation of the information.

(M3) A method may be performed as described in paragraph (M1) or paragraph (M2), and may further involve in response to querying the at least one data source, receiving a plurality of search results corresponding to the first keyword, determining a first search result, from the plurality of search results by ranking the plurality of search results based at least in part on contents of the video, and determining the representation of the information from the information included in the first search result.

(M4) A method may be performed as described paragraph (M3), and may further involve generating a user interface element including the representation of the information and at least one selectable element, wherein the client device is caused to display the user interface element, receiving a user input selecting the at least one selectable element, the user input being indicative of feedback with respect to the information, based at least in part on the user input being indicative of the feedback, selecting a second search result from the plurality of search results, determining a representation of other information included in the second search result; and causing the client device to display the representation of the other information.

(M5) A method may be performed as described in any of paragraphs (M1) through (M4), and may further involve causing the client device to display a representation of at least the first keyword and at least one selectable user interface element to enable a user to provide feedback with respect to the first keyword, receiving a user input indicative of feedback with respect to the first keyword, and based at least in part on the user input being indicative of the feedback, storing updated keywords in the storage medium.

(M6) A method may be performed as described in paragraph (M5), and may further involve after updating the keywords, receiving, via the video playback application, an additional indication that playback of the video is initiated, in response to the additional indication, retrieving the updated keywords from the storage medium, querying the at least one data source for additional information corresponding to the updated keywords, and causing the client device to display a representation of the additional information.

(M7) A method may be performed as described in any of paragraphs (M1) through (M6), and may further involve generating a user interface element including the representation of the information and a selectable user interface element enabling a user to access the at least one data source, receiving a user input selecting the selectable user interface element, and in response to receiving the user input, causing the video playback application to pause playback of the video.

(M8) A method may be performed as described in any of paragraphs (M1) through (M7), and may further involve receiving video data for the video, processing the video data to determine a transcription of the video, and determining, using the transcription of the video, at least the first keyword.

The following paragraphs (S1) through (S8) describe examples of systems and devices that may be implemented in accordance with the present disclosure.

(S1) A computing system may comprise at least one processor and at least one computer-readable medium encoded with instructions which, when executed by the at least one processor, cause the computing system to store, in a storage medium, at least a first keyword corresponding to content of a video, after storing the first keyword, receive, via a video playback application, an indication that playback of the video is initiated, in response to receipt of the indication, retrieve the first keyword from the storage medium, query at least one data source for information corresponding to the first keyword, and cause a client device to display a representation of the information.

(S2) A computing system may be configured as described in paragraph (S1), wherein the at least one computer-readable medium may be further encoded with additional instructions which, when executed by the at least one processor, further cause the computing system to determine the first keyword corresponds to a time marker of the video, store, in the storage medium, the first keyword and data identifying the time marker, determine, using the data identifying the time marker from the storage medium, that playback of the video is at a beginning of the time marker, and in response to determining that playback of the video is at a beginning of the time marker, cause the client device to display the representation of the information.

(S3) A computing system may be configured as described in paragraph (S1) or paragraph (S2), wherein the at least one computer-readable medium may be further encoded with additional instructions which, when executed by the at least one processor, further cause the computing system to in response to querying the at least one data source, receive a plurality of search results corresponding to the first keyword, determine a first search result, from the plurality of search results by ranking the plurality of search results based at least in part on contents of the video, and determine the representation of the information from the information included in the first search result.

(S4) A computing system may be configured as described in paragraph (S3), wherein the at least one computer-readable medium may be further encoded with additional instructions which, when executed by the at least one processor, further cause the computing system to generate a user interface element including the representation of the information and at least one selectable element, wherein the client device is caused to display the user interface element, receive a user input selecting the at least one selectable element, the user input being indicative of feedback with respect to the information, based at least in part on the user input being indicative of the feedback, select a second search result from the plurality of search results, determining a representation of other information included in the second search result, and cause the client device to display the representation of the other information.

(S5) A computing system may be configured as described in any of paragraphs (S1) through (S4), wherein the at least one computer-readable medium may be further encoded with additional instructions which, when executed by the at least one processor, further cause the computing system to cause the client device to display a representation of at least the first keyword and at least one selectable user interface element to enable a user to provide feedback with respect to the first keyword, receive a user input indicative of feedback with respect to the first keyword, and based at least in part on the user input being indicative of the feedback, store updated keywords in the storage medium.

(S6) A computing system may be configured as described in paragraph (S5), wherein the at least one computer-readable medium may be further encoded with additional instructions which, when executed by the at least one processor, further cause the computing system to after updating the keywords, receive, via the video playback application, an additional indication that playback of the video is initiated, in response to the additional indication, retrieve the updated keywords from the storage medium, query the at least one data source for additional information corresponding to the updated keywords, and cause the client device to display a representation of the additional information.

(S7) A computing system may be configured as described in any of paragraphs (S1) through (S6), wherein the at least one computer-readable medium may be further encoded with additional instructions which, when executed by the at least one processor, further cause the computing system to generate a user interface element including the representation of the information and a selectable user interface element enabling a user to access the at least one data source, receive a user input selecting the selectable user interface element, and in response to receiving the user input, cause the video playback application to pause playback of the video.

(S8) A computing system may be configured as described in any of paragraphs (S1) through (S7), wherein the at least one computer-readable medium may be further encoded with additional instructions which, when executed by the at least one processor, further cause the computing system to receive video data for the video, process the video data to determine a transcription of the video, and determine, using the transcription of the video, at least the first keyword.

The following paragraphs (CRM1) through (CRM8) describe examples of computer-readable media that may be implemented in accordance with the present disclosure.

(CRM1) At least one non-transitory computer-readable medium may be encoded with instructions which, when executed by at least one processor of a computing system, may cause the computing system to store, in a storage medium, at least a first keyword corresponding to content of a video, after storing the first keyword, receive, via a video playback application, an indication that playback of the video is initiated, in response to receipt of the indication, retrieve the first keyword from the storage medium, query at least one data source for information corresponding to the first keyword, and cause a client device to display a representation of the information.

(CRM2) At least one non-transitory computer-readable medium may be configured as described in paragraph (CRM1), and may be further encoded with additional instructions which, when executed by the at least one processor, further cause the computing system to determine the first keyword corresponds to a time marker of the video, store, in the storage medium, the first keyword and data identifying the time marker, determine, using the data identifying the time marker from the storage medium, that playback of the video is at a beginning of the time marker, and in response to determining that playback of the video is at a beginning of the time marker, cause the client device to display the representation of the information.

(CRM3) At least one non-transitory computer-readable medium may be configured as described in paragraph (CRM1) or paragraph (CRM2), and may be further encoded with additional instructions which, when executed by the at least one processor, further cause the computing system to in response to querying the at least one data source, receive a plurality of search results corresponding to the first keyword, determine a first search result, from the plurality of search results by ranking the plurality of search results based at least in part on contents of the video, and determine the representation of the information from the information included in the first search result.

(CRM4) At least one non-transitory computer-readable medium may be configured as described in paragraph (CRM3), and may be further encoded with additional instructions which, when executed by the at least one processor, further cause the computing system to generate a user interface element including the representation of the information and at least one selectable element, wherein the client device is caused to display the user interface element, receive a user input selecting the at least one selectable element, the user input being indicative of feedback with respect to the information, based at least in part on the user input being indicative of the feedback, select a second search result from the plurality of search results, determining a representation of other information included in the second search result, and cause the client device to display the representation of the other information.

(CRM5) At least one non-transitory computer-readable medium may be configured as described in any of paragraphs (CRM1) through (CRM4), and may be further encoded with additional instructions which, when executed by the at least one processor, further cause the computing system to cause the client device to display a representation of at least the first keyword and at least one selectable user interface element to enable a user to provide feedback with respect to the first keyword, receive a user input indicative of feedback with respect to the first keyword, and based at least in part on the user input being indicative of the feedback, store updated keywords in the storage medium.

(CRM6) At least one non-transitory computer-readable medium may be configured as described in paragraph (CRM5), and may be further encoded with additional instructions which, when executed by the at least one processor, further cause the computing system to after updating the keywords, receive, via the video playback application, an additional indication that playback of the video is initiated, in response to the additional indication, retrieve the updated keywords from the storage medium, query the at least one data source for additional information corresponding to the updated keywords, and cause the client device to display a representation of the additional information.

(CRM7) At least one non-transitory computer-readable medium may be configured as described in any of paragraphs (CRM1) through (CRM6), and may be further encoded with additional instructions which, when executed by the at least one processor, further cause the computing system to generate a user interface element including the representation of the information and a selectable user interface element enabling a user to access the at least one data source, receive a user input selecting the selectable user interface element, and in response to receiving the user input, cause the video playback application to pause playback of the video.

(CRM8) At least one non-transitory computer-readable medium may be configured as described in any of paragraphs (CRM1) through (CRM7), and may be further encoded with additional instructions which, when executed by the at least one processor, further cause the computing system to receive video data for the video, process the video data to determine a transcription of the video, and determine, using the transcription of the video, at least the first keyword.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer-implemented method comprising:
storing, in a storage medium, at least a first keyword corresponding to content of a video;
after storing the first keyword, receiving, via a video playback application, an indication that playback of the video is initiated;
in response to receipt of the indication, retrieving the first keyword from the storage medium;
querying at least one data source for information corresponding to the first keyword; and
causing a client device to display a representation of the information.

2. The computer-implemented method of claim 1, further comprising:
determining the first keyword corresponds to a time marker of the video;
storing, in the storage medium, the first keyword and data identifying the time marker;
determining, using the data identifying the time marker from the storage medium, that playback of the video is at a beginning of the time marker; and
in response to determining that playback of the video is at a beginning of the time marker, causing the client device to display the representation of the information.

3. The computer-implemented method of claim 1, further comprising:
in response to querying the at least one data source, receiving a plurality of search results corresponding to the first keyword;
determining a first search result, from the plurality of search results by ranking the plurality of search results based at least in part on contents of the video; and
determining the representation of the information from the information included in the first search result.

4. The computer-implemented method of claim 3, further comprising:
generating a user interface element including the representation of the information and at least one selectable element, wherein the client device is caused to display the user interface element;
receiving a user input selecting the at least one selectable element, the user input being indicative of feedback with respect to the information;
based at least in part on the user input being indicative of the feedback, selecting a second search result from the plurality of search results;
determining a representation of other information included in the second search result; and
causing the client device to display the representation of the other information.

5. The computer-implemented method of claim 1, further comprising:
causing the client device to display a representation of at least the first keyword and at least one selectable user interface element to enable a user to provide feedback with respect to the first keyword;
receiving a user input indicative of feedback with respect to the first keyword; and
based at least in part on the user input being indicative of the feedback, storing updated keywords in the storage medium.

6. The computer-implemented method of claim 5, further comprising:
after updating the keywords, receiving, via the video playback application, an additional indication that playback of the video is initiated;
in response to the additional indication, retrieving the updated keywords from the storage medium;
querying the at least one data source for additional information corresponding to the updated keywords; and
causing the client device to display a representation of the additional information.

7. The computer-implemented method of claim 1, further comprising:
generating a user interface element including the representation of the information and a selectable user interface element enabling a user to access the at least one data source;
receiving a user input selecting the selectable user interface element; and
in response to receiving the user input, causing the video playback application to pause playback of the video.

8. The computer-implemented method of claim 1, further comprising:
receiving video data for the video;
processing the video data to determine a transcription of the video; and
determining, using the transcription of the video, at least the first keyword.

9. A computing system, comprising:
at least one processor; and
at least one computer-readable medium encoded with instructions which, when executed by the at least one processor, cause the computing system to:
store, in a storage medium, at least a first keyword corresponding to content of a video;
after storing the first keyword, receive, via a video playback application, an indication that playback of the video is initiated;
in response to receipt of the indication, retrieve the first keyword from the storage medium;
query at least one data source for information corresponding to the first keyword; and
cause a client device to display a representation of the information.

10. The computing system of claim 9, wherein the at least one computer-readable medium is further encoded with additional instructions which, when executed by the at least one processor, further cause the computing system to:
determine the first keyword corresponds to a time marker of the video;
store, in the storage medium, the first keyword and data identifying the time marker;
determine, using the data identifying the time marker from the storage medium, that playback of the video is at a beginning of the time marker; and
in response to determining that playback of the video is at a beginning of the time marker, cause the client device to display the representation of the information.

11. The computing system of claim 9, wherein the at least one computer-readable medium is further encoded with additional instructions which, when executed by the at least one processor, further cause the computing system to:
in response to querying the at least one data source, receive a plurality of search results corresponding to the first keyword;
determine a first search result, from the plurality of search results by ranking the plurality of search results based at least in part on contents of the video; and
determine the representation of the information from the information included in the first search result.

12. The computing system of claim 11, wherein the at least one computer-readable medium is further encoded with additional instructions which, when executed by the at least one processor, further cause the computing system to:
generate a user interface element including the representation of the information and at least one selectable element, wherein the client device is caused to display the user interface element;
receive a user input selecting the at least one selectable element, the user input being indicative of feedback with respect to the information;
based at least in part on the user input being indicative of the feedback, select a second search result from the plurality of search results;
determine a representation of other information included in the second search result; and
cause the client device to display the representation of the other information.

13. The computing system of claim 9, wherein the at least one computer-readable medium is further encoded with additional instructions which, when executed by the at least one processor, further cause the computing system to:
cause the client device to display a representation of at least the first keyword and at least one selectable user interface element to enable a user to provide feedback with respect to the first keyword;
receive a user input indicative of feedback with respect to the first keyword; and
based at least in part on the user input being indicative of the feedback, store updated keywords in the storage medium.

14. The computing system of claim 13, wherein the at least one computer-readable medium is further encoded with additional instructions which, when executed by the at least one processor, further cause the computing system to:
after updating the keywords, receive, via the video playback application, an additional indication that playback of the video is initiated;
in response to the additional indication, retrieve the updated keywords from the storage medium;
query the at least one data source for additional information corresponding to the updated keywords; and
cause the client device to display of a representation of the additional information.

15. The computing system of claim 9, wherein the at least one computer-readable medium is further encoded with additional instructions which, when executed by the at least one processor, further cause the computing system to:
generate a user interface element including the representation of the information and a selectable user interface element enabling a user to access the at least one data source;
receive a user input selecting the selectable user interface element; and
in response to receiving the user input, cause the video playback application to pause playback of the video.

16. The computing system of claim 9, wherein the at least one computer-readable medium is further encoded with additional instructions which, when executed by the at least one processor, further cause the computing system to:
receive video data for the video;
process the video data to determine a transcription of the video; and
determine, using the transcription of the video, at least the first keyword.

17. At least one non-transitory computer-readable medium encoded with instructions which, when executed by at least one processor of a computing system, cause the computing system to:
store, in a storage medium, at least a first keyword corresponding to content of a video;
after storing the first keyword, receive, via a video playback application, an indication that playback of the video is initiated;
in response to receipt of the indication, retrieve the first keyword from the storage medium;
query at least one data source for information corresponding to the first keyword; and
cause a client device to display a representation of the information.

18. The at least one non-transitory computer-readable medium of claim 17, further encoded with additional instructions which, when executed by the at least one processor, further cause the computing system to:
determine the first keyword corresponds to a time marker of the video;
store, in the storage medium, the first keyword and data identifying the time marker;
determine, using the data identifying the time marker from the storage medium, that playback of the video is at a beginning of the time marker; and
in response to determining that playback of the video is at a beginning of the time marker, cause the client device to display the representation of the information.

19. The at least one non-transitory computer-readable medium of claim 17, further encoded with additional instructions which, when executed by the at least one processor, further cause the computing system to:
in response to querying the at least one data source, receive a plurality of search results corresponding to the first keyword;
determine a first search result, from the plurality of search results by ranking the plurality of search results based at least in part on contents of the video; and
determine the representation of the information from the information included in the first search result.

20. The at least one non-transitory computer-readable medium of claim 19, further encoded with additional instructions which, when executed by the at least one processor, further cause the computing system to:
generate a user interface element including the representation of the information and at least one selectable element, wherein the client device is caused to display the user interface element;
receive a user input selecting the at least one selectable element, the user input being indicative of feedback with respect to the information;
based at least in part on the user input being indicative of the feedback, select a second search result from the plurality of search results;
determine a representation of other information included in the second search result; and
cause the client device to display the representation of the other information.
